(19) United States
(12) Patent Application Publication
(10) Pub. No.: US 2025/0240567 A1
(43) Pub. Date: Jul. 24, 2025

(54) ELECTRONIC DEVICE AND METHOD FOR TRANSMITTING AUDIO FROM ELECTRONIC DEVICE TO EXTERNAL ELECTRONIC DEVICE

(71) Applicant: SAMSUNG ELECTRONICS CO., LTD., Suwon-si (KR)

(72) Inventors: Daejin KIM, Suwon-si (KR); Seungseok HONG, Suwon-si (KR); Jeongwook KWON, Suwon-si (KR); Sangheon KIM, Suwon-si (KR); Taeuk PARK, Suwon-si (KR); Yeunwook LIM, Suwon-si (KR)

(73) Assignee: SAMSUNG ELECTRONICS CO., LTD., Suwon-si (KR)

(21) Appl. No.: 19/174,402

(22) Filed: Apr. 9, 2025

Related U.S. Application Data
(63) Continuation of application No. PCT/KR2023/017480, filed on Nov. 3, 2023.

(30) Foreign Application Priority Data
Jan. 13, 2013 (KR) 10-2023-0005716
Dec. 26, 2022 (KR) 10-2022-0184088

(51) Int. Cl. H04R 3/12

(52) U.S. Cl. CPC H04R 3/12; H04R 2420/01; H04R 2420/07

(57) ABSTRACT

An electronic device includes: a display; a communication module; at least one processor; and memory storing instructions that, when executed by the at least one processor individually or collectively, cause the electronic device to: perform an audio mirroring function including, in a state in which an audio is being played on the electronic device, based on identifying a selection for transmitting the audio being played to at least one external electronic device, separating the audio being played from an audio output of the electronic device, recording the separated audio, and transmitting the recorded audio to the at least one external electronic device through the communication module.

### CROSS-REFERENCE TO RELATED APPLICATION(S)

This application is a continuation of International Application No. PCT/KR2023/017480, filed on Nov. 3, 2023, in the Korean Intellectual Property Receiving Office, which is based on and claims priority to Korean Patent Application No. 10-2022-0184088, filed on Dec. 26, 2022 and Korean Patent Application No. 10-2023-0005716, filed on Jan. 13, 2023, in the Korean Intellectual Property Office, the disclosures of which are incorporated by reference herein in their entireties.

### BACKGROUND

### 1. Field

The disclosure relates to an electronic device and a method for transmitting audio from the electronic device to an external electronic device.

### 2. Description of Related Art

An electronic device may play, at high quality, audio provided by an application that supports audio services on the electronic device or audio stored on the electronic device for audio output desired by a user.

Alternatively, the electronic device may play the user's desired audio through an artificial intelligence (AI) speaker connected to a server supporting audio services.

### SUMMARY

Aspects will be set forth in part in the description which follows and, in part, will be apparent from the description, or may be learned by practice of the presented embodiments.

According to an aspect of the disclosure, an electronic device may include: a display; a communication module; at least one processor; and memory storing instructions that, when executed by the at least one processor individually or collectively, cause the electronic device to: perform an audio mirroring function including, in a state in which an audio is being played on the electronic device, based on identifying a selection for transmitting the audio being played to at least one external electronic device, separating the audio being played from an audio output of the electronic device, recording the separated audio, and transmitting the recorded audio to the at least one external electronic device through the communication module.

The instructions, when executed by the at least one processor individually or collectively, may further cause the electronic device to: identify whether a media application providing the audio on the electronic device supports a casting service in which a server of the media application is configured to be able to transmit the audio to the at least one external electronic device; and based on the media application not supporting the casting service, perform the audio mirroring function to transmit the audio being played to the at least one external electronic device.

The instructions, when executed by the at least one processor individually or collectively, may further cause the electronic device to: based on the media application supporting the casting service, transmit, to the at least one external electronic device through the communication module, address information that enables the at least one external electronic device to receive the audio through the communication module from the server of the media application through the casting service.

The instructions, when executed by the at least one processor individually or collectively, may further cause the electronic device to: in the state in which the audio is being played on the electronic device, based on the selection for transmitting the audio being played to the at least one external electronic device, search for the at least one external electronic device communicatively connected through the communication module; control the display to display a list of external electronic devices including the searched at least one external electronic device; and perform the audio mirroring function to transmit the audio being played to an external electronic device selected from the list of the external electronic devices.

The instructions, when executed by the at least one processor individually or collectively, may further cause the electronic device to: identify whether a media application providing the audio supports the audio mirroring function or whether the at least one external electronic device supports the audio mirroring function; and based on the media application supporting the audio mirroring function or the at least one external electronic device supporting the audio mirroring function, perform the audio mirroring function to transmit the audio being played to the at least one external electronic device.

The instructions, when executed by the at least one processor individually or collectively, may further cause the electronic device to: based on a selection of an audio casting function being identified in a state in which the audio being played is transmitted through the audio mirroring function to a first external electronic device among the at least one external electronic device, identify whether a media application providing the audio supports a casting service in which a server of the media application is configured to be able to transmit the audio to the external electronic device; and based on the media application supporting the casting service, transmit, to a second external electronic device among the at least one external electronic device, address information that enables the second external electronic device to receive the audio through the communication module from the server of the media application through the audio casting function.

The instructions, when executed by the at least one processor individually or collectively, may further cause the electronic device to: in a state in which a first audio provided from a first media application through the audio mirroring function is transmitted to a first external electronic device among the at least one external electronic device, based on identifying a selection of the audio mirroring function for a second audio provided from a second media application, perform the audio mirroring function to transmit the second audio to a second external electronic device among the at least one external electronic device.

The instructions, when executed by the at least one processor individually or collectively, may further cause the electronic device to: in a state in which a server of a first media application transmits a first audio to a second external electronic device among the at least one external electronic device through an audio casting function, based on identifying a selection of the audio mirroring function for a second audio provided from a second media application, perform the audio mirroring function to transmit the second audio from the electronic device to a first external electronic device among the at least one external electronic device.

The instructions, when executed by the at least one processor individually or collectively, may further cause the electronic device to: in a state in which the audio being played is transmitted to a first external electronic device among the at least one external electronic device through the audio mirroring function, based on a selection for changing the audio being transmitted to a second external electronic device among the at least one external electronic device through an audio casting function, control the display to display a button for moving to a media application providing the audio to change to the second external electronic device.

The instructions, when executed by the at least one processor individually or collectively, may further cause the electronic device to: display a first icon indicating the electronic device and at least one second icon indicating the at least one external electronic device, identify a second icon selected to be related to the first icon through a gesture among the at least one second icon, and transmit the audio being played to an external electronic device corresponding to the identified second icon through the audio mirroring function or an audio casting function.

According to an aspect of the disclosure, an electronic device may include: a communication module; at least one processor; and memory storing instructions that, when executed by the at least one processor individually or collectively, cause the electronic device to: receive type information for receiving an audio from a plurality of external electronic devices communicatively connected through the communication module, wherein the type information indicates a capability of the plurality of external electronic devices to perform of an audio mirroring function or an audio casting function; and in a state in which the electronic device plays a first audio provided from a first media application, transmit the first audio through the audio mirroring function to a first external electronic device; play a second audio provided from a second media application, on the electronic device, in a state in which the first audio is being transmitted to the first external electronic device through the audio mirroring function; and in a state in which the electronic device is playing the second audio provided from the second media application, transmit the second audio, through the audio casting function, to a second external electronic device.

The audio mirroring function may include separating the first audio being played on the electronic device from an audio output from the electronic device, recording the separated first audio, and transmitting the recorded first audio to the first external electronic device through the communication module.

The instructions, when executed by the at least one processor individually or collectively, may further cause the electronic device to: transmit, to the second external electronic device, address information that enables the second external electronic device to receive the second audio through the communication module from a server of the second media application through the audio casting function.

According to an aspect of the disclosure, a method for transmitting an audio to an external electronic device by an electronic device may include: playing an audio on the electronic device; and performing an audio mirroring function including: based on identifying a selection for transmitting the audio being played to an external electronic device, separating the audio being played from an audio output of the electronic device, recording the separated audio, and transmitting the recorded audio to the external electronic device through a communication module of the electronic device.

The method may further include: identifying whether a media application providing the audio on the electronic device supports a casting service in which a server of the media application is configured to be able to transmit the audio to the external electronic device; and based on the media application not supporting the casting service, performing the audio mirroring function to transmit the audio being played to the external electronic device.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a view illustrating an electronic device in a network environment according to an embodiment;

FIG. 2 is a view illustrating an operation of transmitting an audio of an electronic device to an external electronic device according to an embodiment;

FIG. 3 is a block diagram illustrating an electronic device according to an embodiment;

FIGS. 4A and 4B are flowcharts illustrating an operation of transmitting an audio from an electronic device to an external electronic device according to one or more embodiments;

FIG. 5 is a view illustrating an operation of transmitting an audio from an electronic device to an external electronic device according to an embodiment;

FIGS. 6A and 6B are views illustrating an operation of providing a list of external electronic devices by an electronic device according to one or more embodiments;

FIGS. 7A and 7B are views illustrating an operation of transmitting an audio being played on an electronic device to an external electronic device according to one or more embodiments;

FIGS. 8A, 8B, 8C, and 8D are views illustrating operations of transmitting an audio being played on an electronic device to an external electronic device according to one or more embodiments;

FIGS. 9A, 9B, and 9C are views illustrating operations of transmitting an audio being played on an electronic device to an external electronic device according to one or more embodiments;

FIGS. 10A, 10B, and 10C are views illustrating operations of selecting an external electronic device for transmitting an audio being played on an electronic device according to one or more embodiments;

FIG. 11 is a view illustrating operations of selecting an external electronic device for transmitting an audio being played on an electronic device according to an embodiment; and

FIG. 12 is a view illustrating operations of selecting an external electronic device for transmitting an audio being played on an electronic device according to an embodiment.

### DETAILED DESCRIPTION

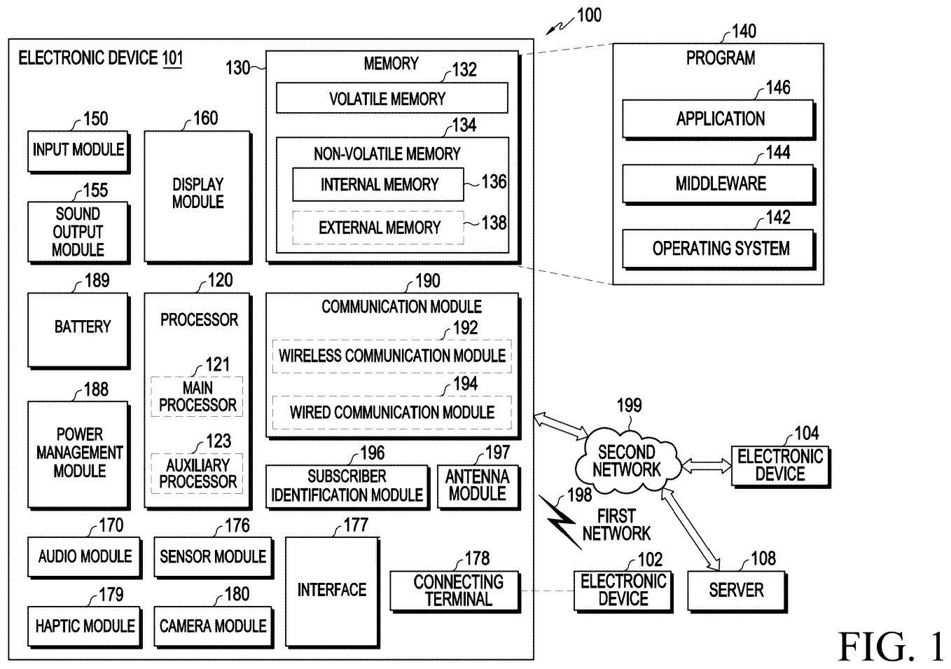

FIG. 1 is a block diagram illustrating an electronic device 101 in a network environment 100 according to an embodiment. Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non- volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

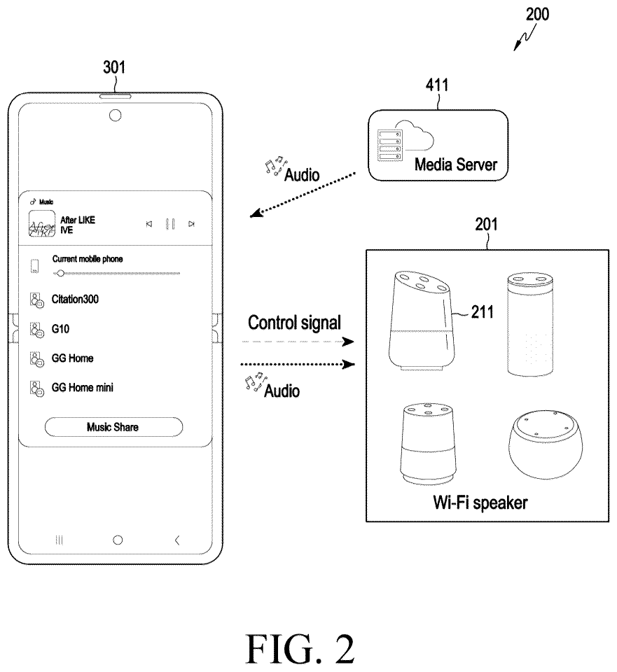

FIG. 2 is a view 200 illustrating an operation of transmitting an audio of an electronic device to an external electronic device according to an embodiment.

Referring to FIG. 2, according to an embodiment, an electronic device 301 may transmit an audio being played on the electronic device to an external electronic device 211 selected by the user among at least one external electronic device 201 through an audio mirroring function.

According to an embodiment, the audio mirroring function of separating the audio being played from all the audio being output from the electronic device 301, recording the separated audio, and transmitting the recorded audio to the external electronic device 211 through a communication module (e.g., a Wi-Fi communication module) of the electronic device may be performed. For example, the electronic device 301 may perform the audio mirroring function of, when a call-related audio or game-related audio is output while playing music audio, separating the music audio, recording the separated music audio, and transmitting the recorded music audio to the external electronic device 211.

According to an embodiment, the electronic device 301 may, while playing the audio received in real-time from an application providing audio (hereinafter, referred to as a “media application”) and/or video stored in the electronic device, transmit the audio being played to the external electronic device 211 through the audio mirroring function so that the external electronic device 211 may continuously play the audio being played on the electronic device.

According to an embodiment, the electronic device 301 may, while playing the audio stored in the electronic device, transmit the audio being played to the external electronic device 211 through the audio mirroring function so that the external electronic device 211 may continuously play the audio being played on the electronic device.

According to an embodiment, the electronic device 301 may, if the media application does not support a casting service capable of transmitting audio to the external electronic device by the server 355 of the media application, transmit the audio being played on the electronic device 301 to the external electronic device 211 through the audio mirroring function.

According to an embodiment, the electronic device 301 may transmit a control signal (e.g., http stream control) for transmitting audio in real-time through the audio mirroring function, together with the audio, to the external electronic device 211.

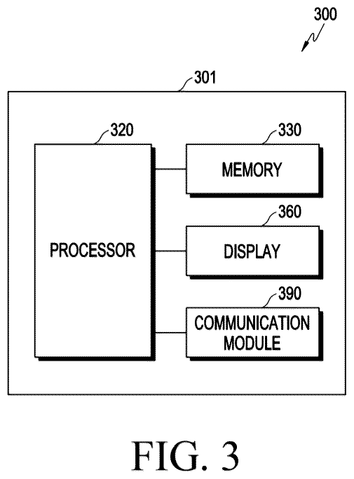

The configuration of the electronic device 301 may be described in detail in FIG. 3.

According to an embodiment, at least one external electronic device 201 may include an electronic device capable of outputting audio, such as a speaker and/or a TV.

According to an embodiment, the at least one external electronic device 201 may include a communication module capable of communicating with the electronic device. For example, the communication module may include a Wi-Fi communication module.

According to an embodiment, an external electronic device including first type information capable of an audio mirroring function among the at least one external electronic device 201 may, if receiving audio from the electronic device 201 through a communication module of the external electronic device using the audio mirroring function performed by the electronic device, play the received audio.

According to an embodiment, an external electronic device including second type information capable of an audio casting function among the at least one external electronic device 201 may, if receiving audio from the electronic device 201 through a communication module of the external electronic device using the audio mirroring function performed by the electronic device, play the received audio.

According to an embodiment, the external electronic device including the second type information capable of the audio casting function among the at least one external electronic device 201 may, if receiving audio from the server 355 of the media application providing the audio being played on the electronic device 201 using the casting function performed by the electronic device, play the received audio.

FIG. 3 is a block diagram 300 illustrating an electronic device according to an embodiment.

Referring to FIG. 3, according to an embodiment, an electronic device 301 may include a processor 320, memory 330, a display 360, and a communication module 390.

At least some of the components of the electronic device 301 shown in FIG. 3 may be the same as or similar to the components of the electronic device 101 of FIG. 1, and no duplicate description is given below.

According to an embodiment, the processor 320 may be implemented to be substantially the same as or similar to the processor 120 of FIG. 1.

According to an embodiment, if identifying the user's selection for outputting the audio being played on the electronic device 301 to an external electronic device (e.g., the external electronic device 211 of FIG. 2), the processor 320 may perform an audio mirroring function of transmitting the audio being played among various audios output from the electronic device 301 to the external electronic device.

According to an embodiment, the processor 320 may, if identifying a selection of media output on a menu for transmitting the audio to the external electronic device while playing the audio provided from the media application stored in the electronic device 301, control the display 360 to display a list of first external electronic devices including information about at least one first external electronic device (e.g., the at least one external electronic device 201 of FIG. 2) where the type information for audio reception includes first type information capable of the audio mirroring function.

According to an embodiment, if identifying a selection of the media output menu for transmitting the audio to the external electronic device, the processor 320 may identify whether the media application supports a casting service in which the server of the media application may transmit audio to the external electronic device and, if identifying that the media application does not support the casting service, control the display 360 to display the list of the first external electronic devices.

According to an embodiment, the processor 320 may, if identifying a selection of the media output which is a menu for transmitting the audio to the external electronic device while playing the audio stored in the memory 330 of the electronic device 301, control the display 360 to display the list of the first external electronic devices.

According to an embodiment, the processor 320 may perform an audio mirroring function of identifying a first external electronic device (e.g., the external electronic device (e.g., an external speaker) 211 of FIG. 2) selected by the user from the list of the first external electronic devices, separating the audio being played on the electronic device 301 (e.g., the audio provided from the media application or the audio stored in the memory 330 of the electronic device 301) among various audios output from the electronic device 301, recording the separated audio, and transmitting the recorded audio to the first external electronic device through the communication module 390.

According to an embodiment, the processor 320 may transmit a control signal (e.g., http stream control) for transmitting audio in real-time through the audio mirroring function to the first external electronic device.

According to an embodiment, to transmit the audio being played on the electronic device to the first external electronic device through the audio mirroring function, the processor 320 may separate the audio being played (e.g., music audio) among various audios (e.g., audio output through execution of a game application or audio output through execution of a call application) output from the electronic device, record the separated audio, and transmit the recorded audio to the first external electronic device.

According to an embodiment, the processor 320 may identify the first external electronic device (e.g., an external speaker) selected by the user from the list of the first external electronic devices, identify whether the selected first external electronic device or the media application supports the audio mirroring function and, if identifying that the selected first external electronic device or the media application supports the audio mirroring function, transmit the audio being played on the electronic device to the first external electronic device through the audio mirroring function.

According to an embodiment, the processor 320 may not perform the audio mirroring function for transmitting the audio being played on the electronic device to the first external electronic device if identifying that the selected first external electronic device or the media application does not support the audio mirroring function.

For example, when the service is one where video and audio sync is important in the media application, the audio mirroring function of transmitting audio to the first external electronic device may not be supported in the media application.

For example, the first external electronic device which has video output as default such as a TV or a settop box may not support the audio mirroring function.

According to an embodiment, the processor 320 may, if identifying that the media application supports the casting service in which the server of the media application may directly transmit audio to the external electronic device, and media output as a menu for transmitting the audio to the external electronic device is selected, control the display 360 to display a list of second external electronic devices including information about at least one second external electronic device where the type information for audio reception includes second type information capable of the audio casting function.

According to an embodiment, the processor 320 may identify the second external electronic device selected by the user from the list of the second external electronic devices and transmit address information (e.g., URL information about the audio being played on the server of the media application) capable of receiving audio to the second external electronic device through the communication module 390 so that the second external electronic device performs the audio casting function capable of receiving the audio being played on the electronic device from the server of the media application.

According to an embodiment, the processor 320 may continuously play the audio used to be played on the electronic device through the second external electronic device selected by the user among the at least one second external electronic device including the second type information capable of the audio casting function using the audio casting function based on the user's selection while playing the audio provided from the media application supporting the casting service on the electronic device. The processor 320 may, if the audio mirroring function is selected based on the user's selection while playing the audio provided from the media application on the second external electronic device using the audio casting function, stop playing audio on the second external electronic device through the audio casting function and transmit the audio provided from the media application through the audio mirroring function to a first external electronic device selected by the user among the at least one first external electronic device including the first type information capable of the audio mirroring function so that the first external electronic device may continuously play the audio used to be played on the second external electronic device.

According to an embodiment, the processor 320 may continuously play the audio used to be played on the electronic device through the first external electronic device selected by the user among the at least one first external electronic device including the first type information capable of the audio mirroring function through the audio mirroring function based on the user's selection while playing the audio provided from the media application supporting the casting service on the electronic device. The processor 320 may, if the audio casting function is selected based on the user's selection while playing the audio provided from the media application on the first external electronic device through the audio mirroring function, stop playing audio on the first external electronic device through the audio mirroring function and transmit the audio provided from the media application through the audio casting function to a second external electronic device selected by the user among the at least one second external electronic device including the second type information capable of the audio casting function so that the second external electronic device may continuously play the audio used to be played on the first external electronic device.

According to an embodiment, the processor 320 may continuously play the audio used to be played on the electronic device through the second external electronic device including the second type information capable of the audio casting function through the audio casting function based on the user's selection while playing the first audio provided from the first media application supporting the casting service on the electronic device. The processor 320 may, if identifying a selection of the audio mirroring function for the second audio provided from the second media application while playing the first audio provided from the first media application on the second external electronic device through the audio casting function, stop playing the first audio on the second external electronic device through the audio casting function and play the second audio provided from the second media application through the audio mirroring function on a first external electronic device selected by the user among the at least one first external electronic device including the first type information capable of the audio mirroring function.

According to an embodiment, the processor 320 may continuously play the first audio used to be played on the electronic device through the first external electronic device selected by the user among the at least one first external electronic device including the first type information capable of the audio mirroring function through the audio mirroring function based on the user's selection while playing the first audio provided from the first media application on the electronic device. The processor 320 may, if identifying a selection of the audio casting function for the second audio provided from the second media application supporting the casting service while playing the first audio provided from the first media application on the first external electronic device through the audio mirroring function, stop playing the first audio on the first external electronic device through the audio mirroring function and play the second audio provided from the second media application through the audio casting function on a second external electronic device selected by the user among the at least one second external electronic device including the second type information capable of the audio casting function.

According to an embodiment, the processor 320 may display a list of external electronic devices including information about at least one first external electronic device including first type information capable of the audio mirroring function and information about at least one second external electronic device including second type information capable of the audio casting function, based on the user's selection on a media panel displaying buttons (e.g., play/pause buttons and previous/next song play buttons) capable of controlling audio and information about the audio being played on the electronic device. The processor 320 may perform both the audio mirroring function capable of transmitting the audio being played on the electronic device to a first external electronic device selected by the user from the list of the external electronic devices and the audio casting function capable of transmitting the audio being played on the electronic device to a second external electronic device selected by the user from the list of the external electronic devices.

According to an embodiment, the processor 320 may perform the audio mirroring function capable of transmitting the audio being played on the electronic device to the first external electronic device selected from the list of the external electronic devices while displaying the list of the external electronic devices on the media panel. If the audio casting function capable of transmitting the audio being played on the electronic device to the second external electronic device selected from the list of the external electronic devices, the processor 320 may display a button capable of moving to the media application along with a message indicating that the audio being played should be moved to the media application.

According to an embodiment, the processor 320 may distinctly display the performing of the audio mirroring function and the performing of the audio casting function on the media panel.

According to an embodiment, when providing the list of the first external electronic devices including the information about the at least one first external electronic device including the first type information capable of the audio mirroring function, the list of the second external electronic devices including the information about the at least one second external electronic device including the second type information capable of the audio casting function, or a list of external electronic devices including the information about the at least one first external electronic device including the first type information capable of the audio mirroring function and the information about the at least one second external electronic device including the second type information capable of the audio casting function, the processor 320 may control the display 360 to display a first icon indicating the electronic device and at least one second icon indicating at least one external electronic device (e.g., the first external electronic device and/or the second external electronic device) and perform the audio mirroring function or audio casting function of transmitting the audio being played to the external electronic device (e.g., the first external electronic device and/or the second external electronic device) corresponding to a second icon selected through a gesture among the at least one second icon. For example, the processor 320 may perform the audio mirroring function or the audio casting function of transmitting the audio being played to an external electronic device (e.g., the first external electronic device and/or the second external electronic device) corresponding to a second icon that is moved to the position of the first icon among the at least one second icon or a second icon that overlaps the first icon as the first icon moves among the at least one second icon through a drag-and-drop operation.

According to an embodiment, the processor 320 may transmit the first audio provided from the first media application to the first external electronic device among the plurality of external electronic devices using the audio mirroring function and, while transmitting the first audio to the first external electronic device using the audio mirroring function, transmit the second audio provided from the second media application to the second external electronic device among the plurality of external electronic devices using the audio casting function.

According to an embodiment, the processor 320 may receive type information for receiving an audio from a plurality of external electronic devices communicatively connected with the electronic device.

According to an embodiment, the type information for audio reception may include first type information capable of the audio mirroring function and/or second type information capable of the audio casting function.

According to an embodiment, the processor 320 may, while playing the first audio provided from the first media application selected by the user on the electronic device 301, identify a selection for transmitting the first audio to an external electronic device and, if identifying that the first media application providing the first audio does not support a casting service in which the server of the first media application may transmit audio to the external electronic device, transmit the first audio to the first external electronic device including the first type information capable of the audio mirroring function among the plurality of external electronic devices using the audio mirroring function. The processor 320 may provide the list of the first external electronic devices including the information about at least one first external electronic device where the type information for audio reception includes the first type information capable of the audio mirroring function among the plurality of external electronic devices.

According to an embodiment, the processor 320 may perform the audio mirroring function of separating the first audio provided from the first media application being played on the electronic device among various audios output from the electronic device 301, recording the separated first audio, and transmitting the recorded first audio to the first external electronic device through the communication module (390) of the electronic device.

According to an embodiment, the processor 320 may, while transmitting the first audio provided from the first media application to the first external electronic device through the audio mirroring function, play the second audio provided from the second media application selected by the user on the electronic device 301. The processor 320 may, while playing the second audio provided from the second media application, identify a selection for transmitting the second audio to an external electronic device and, if identifying that the second media application providing the second audio supports a casting service in which the server of the second media application may transmit audio to the external electronic device, transmit the second audio to the second external electronic device including the second type information capable of the audio casting function among the plurality of external electronic devices using the audio casting function. The processor 320 may provide the list of the second external electronic devices including the information about at least one second external electronic device where the type information for audio reception includes the second type information capable of the audio casting function among the plurality of external electronic devices.

According to an embodiment, the processor 320 may transmit address information (e.g., URL information about the audio being played on the server of the second media application) capable of receiving audio to the second external electronic device through the communication module (390) to perform the audio casting function capable of receiving the second audio being played on the electronic device 301.

According to an embodiment, the memory 330 may be implemented to be substantially the same or similar to the memory 130 of FIG. 1.

According to an embodiment, the memory 330 may store audio (e.g., music audio) or a moving picture including audio and video.

According to an embodiment, the display 360 may be implemented in substantially the same or similar manner to the display module 160 of FIG. 1.

According to an embodiment, the display 360 may display a media panel that displays information about the audio being played and buttons (e.g., play/pause buttons and previous/next song play buttons) capable of controlling audio.

According to an embodiment, the display 360 may display a list of external electronic devices including information about at least one external electronic device.

According to an embodiment, the display 360 may display a first icon indicating the electronic device and at least one second icon indicating at least one external electronic device.

According to an embodiment, the communication module 390 may be implemented to be substantially identical or similar to the communication module 190 of FIG. 1 and may include a plurality of communication circuits using different communication technologies.

According to an embodiment, the communication module 390 may include at least one of a wireless LAN module (not illustrated) and a short-range communication module (not illustrated), and may include an ultra-wide band (UWB) communication module, a Wi-Fi communication module, an NFC communication module, a Bluetooth legacy communication module, and/or a BLE communication module as the short-range communication module (not illustrated).

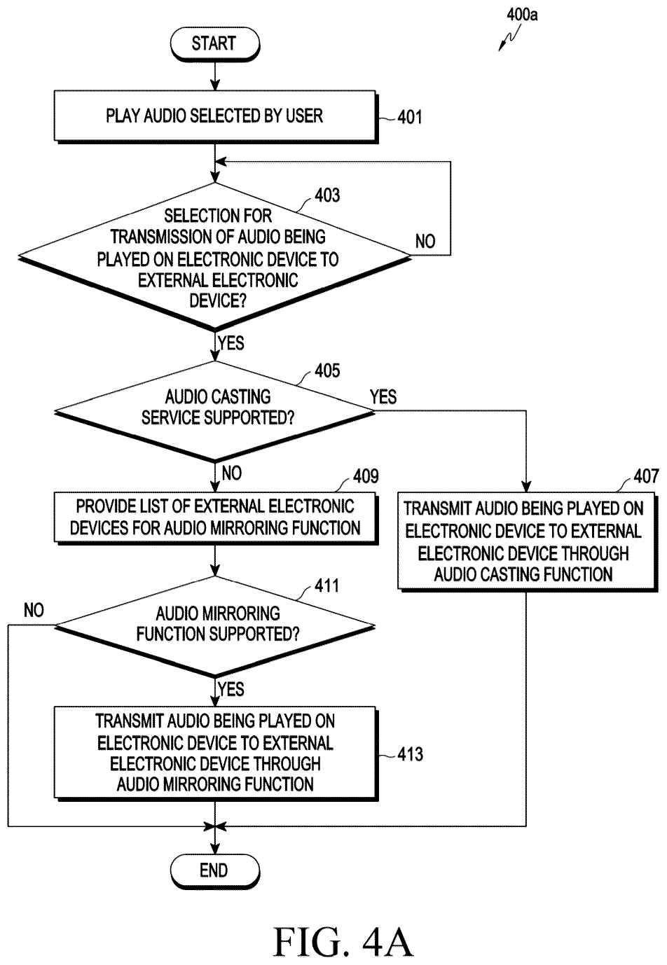

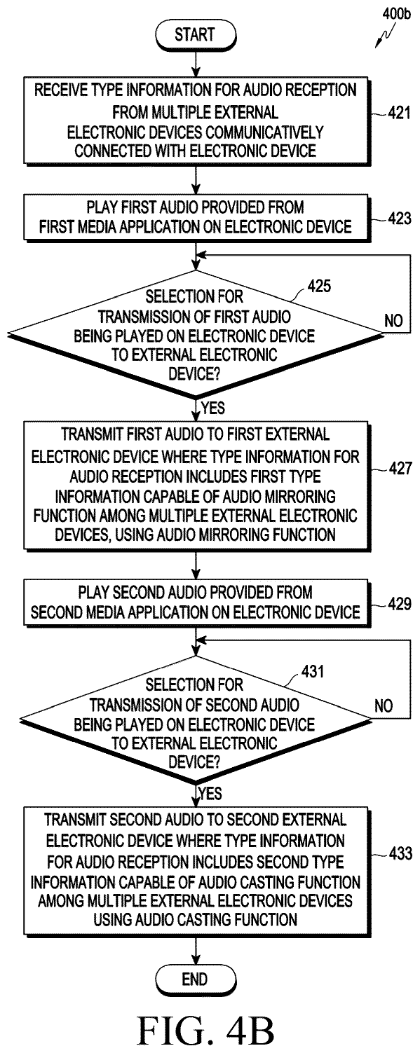

FIG. 4A is a view 400a illustrating an operation of transmitting an audio from an electronic device to an external electronic device according to an embodiment. The operations of transmitting audio to an external electronic device may include operations 401 to 413. In the following embodiment, each operation may be sequentially performed, but is not necessarily performed sequentially. For example, the order of the operations may be changed, and at least two operations may be performed in parallel or other operations may be added.

In operation 401, the electronic device (e.g., the electronic device 101 of FIG. 1, the electronic device 301 of FIG. 2 and/or the electronic device 301 of FIG. 3) may play an audio selected by the user.

According to an embodiment, the electronic device may receive and play audio provided in real-time from a media application stored in the electronic device.

According to an embodiment, the electronic device may play the audio stored in the memory (e.g., the memory 320 of FIG. 3) of the electronic device.

In operation 403, the electronic device (e.g., the electronic device 101 of FIG. 1, the electronic device 301 of FIG. 2 and/or the electronic device 301 of FIG. 3) may identify a selection for transmitting the audio being played on the electronic device to the external electronic device.

The electronic device may, if not identifying a selection for transmitting the audio being played on the electronic device to the external electronic device in operation 403, keep playing the audio on the electronic device.

The electronic device may, if identifying a selection for transmitting the audio being played on the electronic device to the external electronic device in operation 403, identify whether the audio casting service is supported in operation 405.

According to an embodiment, the electronic device may, if identifying a selection of media output on a menu for transmitting audio to the external electronic device, displayed on at least a portion of the display (e.g., the display 360 of FIG. 3) of the electronic device while playing audio on the electronic device, identify a selection for transmitting the audio being played on the electronic device to the external electronic device.

According to an embodiment, when playing the audio provided from the media application, the electronic device may identify whether the media application supports a casting service in which the server of the media application may transmit audio to the external electronic device.

If identifying that the media application supports the audio casting service in operation 405, the electronic device may transmit the audio being played on the electronic device to the external electronic device through the audio casting function in operation 407.

According to an embodiment, the electronic device may provide a list of second external electronic devices including information about at least one second external electronic device including second type information capable of the audio casting function capable of receiving audio through the audio casting function.

According to an embodiment, if identifying a selection of a second external electronic device by the user from the list of the second external electronic devices capable of receiving audio through the audio casting function, the electronic device may transmit address information (e.g., URL information about the audio being played on the server of the media application) capable of receiving audio to the second external electronic device through the communication module (e.g., the communication module 390 of FIG. 3) to perform the audio casting function capable of receiving the second audio being played on the electronic device.

According to an embodiment, the second external electronic device may request the audio being played on the electronic device from the server of the media application based on the address information (e.g., the URL information about the audio being played on the server of the media application) received from the electronic device and play the received audio through the server.

If identifying that the media application does not support the audio casting service in operation 405, the electronic device may provide a list of first external electronic devices for the audio mirroring function in operation 409.

According to an embodiment, when playing the audio (e.g., local file sound source) stored in the memory of the electronic device, the electronic device may skip operation 405 of identifying whether the audio casting service is supported and perform operation 409.

According to an embodiment, the electronic device may control the display (e.g., the display 360 of FIG. 3) of the electronic device to display a list of first external electronic devices including information about at least one first external electronic device (e.g., the at least one external electronic device 201 of FIG. 2) including first type information capable of the audio mirroring function capable of transmitting audio through the audio mirroring function.

In operation 411, the electronic device (e.g., the electronic device 101 of FIG. 1, the electronic device 301 of FIG. 2 and/or the electronic device 301 of FIG. 3) may identify whether the audio mirroring function is supported.

According to an embodiment, the electronic device may identify a first external electronic device (e.g., an external speaker) selected by the user from the list of the first external electronic devices and identify whether the selected first external electronic device supports the audio mirroring function.

According to an embodiment, the electronic device may identify whether the media application providing audio on the electronic device supports the audio mirroring function.

If not identifying that the audio mirroring function is supported in operation 411, the electronic device may not perform the operation of transmitting the audio being played on the electronic device to the first external electronic device through the audio mirroring function.

If identifying that the audio mirroring function is supported in operation 411, the electronic device may transmit the audio being played on the electronic device to the first external electronic device through the audio mirroring function.

According to an embodiment, the electronic device may perform an audio mirroring function of separating the audio being played on the electronic device (e.g., the audio provided from the media application or the audio stored in the memory (e.g., the memory 330 of FIG. 3) of the electronic device) from various audios output from the electronic device, recording the separated audio, and transmitting the recorded audio to the first external electronic device through the communication module (e.g., the communication module 390 of FIG. 3).

According to an embodiment, the electronic device may transmit a control signal (e.g., http stream control) for transmitting audio in real-time through the audio mirroring function to the external electronic device.

FIG. 4B is a view 400b illustrating an operation of transmitting an audio from an electronic device to an external electronic device according to an embodiment. The operations of transmitting audio to an external electronic device may include operations 421 to 433. In the following embodiment, each operation may be sequentially performed, but is not necessarily performed sequentially. For example, the order of the operations may be changed, and at least two operations may be performed in parallel or other operations may be added.

In operation 421, the electronic device (e.g., the electronic device 101 of FIG. 1, the electronic device 301 of FIG. 2 and/or the electronic device 301 of FIG. 3) may receive type information for receiving audio from a plurality of external electronic devices communicatively connected with the electronic device.

According to an embodiment, the type information for audio reception may include first type information capable of the audio mirroring function and/or second type information capable of the audio casting function.

In operation 423, the electronic device (e.g., the electronic device 101 of FIG. 1, the electronic device 301 of FIG. 2, and/or the electronic device 301 of FIG. 3) may play the first audio provided from the first media application on the electronic device.

According to an embodiment, the electronic device may play, on the electronic device, the first audio provided by a server of a first media application selected by the user.

In operation 425, the electronic device (e.g., the electronic device 101 of FIG. 1, the electronic device 301 of FIG. 2 and/or the electronic device 301 of FIG. 3) may identify a selection for transmitting the first audio being played on the electronic device to the external electronic device.

If identifying a selection for transmitting the first audio being played on the electronic device to the external electronic device in operation 425, the electronic device may transmit the first audio to the first external electronic device where the type information for audio reception includes first type information capable of the audio mirroring function among the plurality of external electronic devices using the audio mirroring function in operation 427.

According to an embodiment, if identifying that the first media application providing the first audio does not support the casting service in which the server of the media application may transmit audio to the external electronic device, the electronic device may display a list of first external electronic devices including information about at least one first external electronic device where the type information for audio reception includes first type information capable of the audio mirroring function among the plurality of external electronic devices. The electronic device may transmit the first audio to a first external electronic device selected from the list of the first external electronic devices using the audio mirroring function.

According to an embodiment, the electronic device may perform the audio mirroring function of separating the first audio provided from the first media application being played on the electronic device among all the audios output from the electronic device, recording the separated first audio, and transmitting the recorded first audio to the first external electronic device through the communication module (e.g., the communication module 390 of FIG. 3) of the electronic device.

According to an embodiment, the electronic device may perform operation 421 for receiving the type information for receiving audio from the plurality of external electronic devices communicatively connected with the electronic device after identifying a selection for transmitting the first audio being played on the electronic device to the external electronic device.

In operation 429, the electronic device (e.g., the electronic device 101 of FIG. 1, the electronic device 301 of FIG. 2, and/or the electronic device 301 of FIG. 3) may play the second audio provided from the second media application on the electronic device.

According to an embodiment, the electronic device may play the second audio provided from the server of the second media application selected by the user on the electronic device while transmitting the first audio provided from the first media application to the first external electronic device through the audio mirroring function.

In operation 431, the electronic device (e.g., the electronic device 101 of FIG. 1, the electronic device 301 of FIG. 2 and/or the electronic device 301 of FIG. 3) may identify a selection for transmitting the second audio being played on the electronic device to the external electronic device.

If identifying a selection for transmitting the second audio being played on the electronic device to the external electronic device in operation 431, the electronic device may transmit the second audio to the second external electronic device where the type information for audio reception includes second type information capable of the audio casting function among the plurality of external electronic devices using the audio casting function in operation 433.

According to an embodiment, if identifying that the second media application providing the second audio supports the casting service in which the server of the media application may transmit audio to the external electronic device, the electronic device may display a list of second external electronic devices including information about at least one second external electronic device where the type information for audio reception includes second type information capable of the audio casting function among the plurality of external electronic devices. The electronic device may transmit the second audio to a second external electronic device selected from the list of the second external electronic devices using the audio casting function.

According to an embodiment, the electronic device may transmit address information (e.g., URL information about the audio being played on the server of the second media application) capable of receiving audio to the second external electronic device through the communication module (e.g., the communication module 390 of FIG. 3) to perform the audio casting function capable of receiving the second audio being played on the electronic device.

According to an embodiment, the second external electronic device may request the second audio being played on the electronic device from the server of the second media application based on the address information (e.g., the URL information about the audio being played on the server of the second media application) received from the electronic device and play the second audio received from the server.

FIG. 4B illustrates an operation of transmitting the second audio to the second external electronic device using the casting function while transmitting the first audio to the first external electronic device using the audio mirroring function, but the operation of transmitting the first audio to the first external electronic device using the audio mirroring function while transmitting the second audio to the second external electronic device using the casting function may also be performed in the same manner.

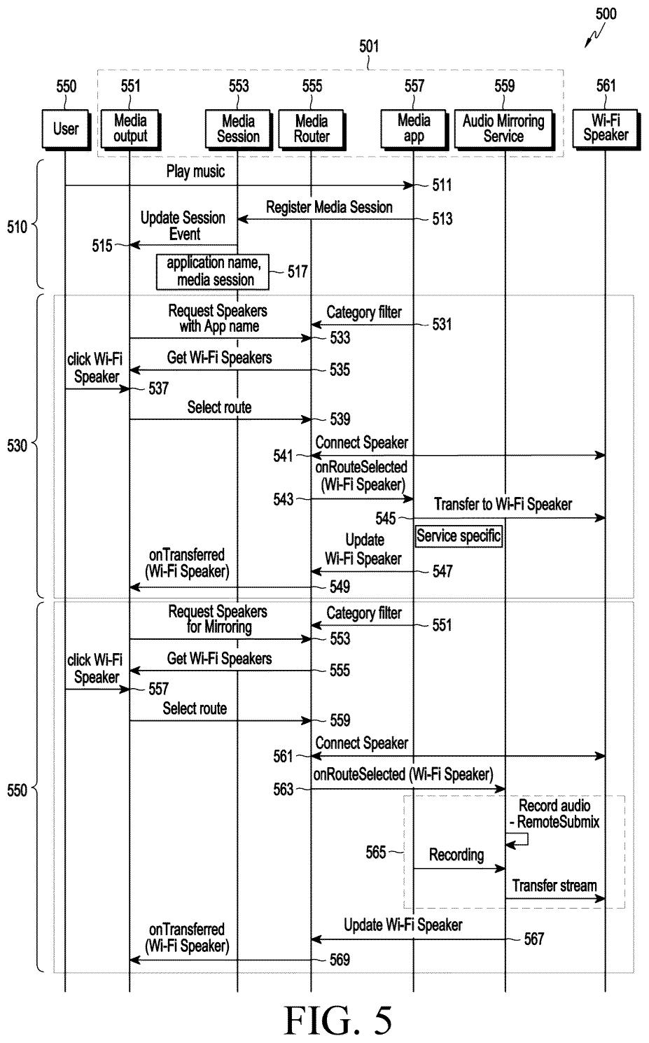

FIG. 5 is a view 500 illustrating an operation of transmitting an audio from an electronic device to an external electronic device according to an embodiment.

Referring to FIG. 5, an electronic device 501 (e.g., the electronic device 101 of FIG. 1, the electronic device 201 of FIG. 2, and/or the electronic device 301 of FIG. 3) may include a media output unit 551, a media session unit 553, a media router unit 555, a media application unit 557, and an audio mirroring service unit 559 to transmit audio to an external electronic device.

According to an embodiment, the media output unit 551 may change the audio path of the electronic device and may perform a function of providing media information.

According to an embodiment, the media session unit 553 may perform a function of a framework for managing session information (playback state and/or metadata) of media (video and/or audio) registered in a media application and providing media information.

According to an embodiment, the media router unit 555 may perform a function of a framework to manage the external electronic device (e.g., an external speaker) to which audio is to be transmitted and provide external electronic device information (e.g., external speaker information). The media router unit 555 may transmit audio to the external electronic device through an internal web server (e.g., an http server) of the electronic device.

According to an embodiment, the media application unit 557 may represent an application capable of providing audio and/or video through a server in real-time.

According to an embodiment, the audio mirroring service unit 559 may perform an audio recording function of a media application selected by the user, connect to an external electronic device, record the audio of the media application selected by the user to the connected external electronic device, and perform the function of transmitting the recorded audio. The audio mirroring service unit 559 may record and output audio and/or video using a remote submix.

According to an embodiment, the media output unit 551, the media session unit 553, the media router unit 555, and the audio mirroring service unit 559 included in the electronic device 501 may be included in the processor (e.g., the processor 120 of FIG. 1 and/or the processor 320 of FIG. 3) of the electronic device or may be configured separately.

According to an embodiment, the respective functions and/or operations of the media output unit 551, the media session unit 553, the media router unit 555, and the audio mirroring service unit 559 included in the electronic device 501 may be equally performed by the processor (e.g., the processor 120 of FIG. 1 and/or the processor 320 of FIG. 3) of the electronic device.

The operation of transmitting audio to the external electronic device (e.g., a Wi-Fi speaker) by the electronic device 501 is described with reference to FIG. 5. In process 510, the electronic device 501 may obtain a media service and/or session information.

Process 510 is described. In operation 511, the media application unit 557 may receive an audio playback event to request audio playback from the user 550.

In operation 513, the media application unit 557 may request the media session unit 553 to register session information (playback state and/or metadata) about the audio selected to be played corresponding to the audio playback event.

In operation 515, the media session unit 553 may register the session information (playback state and/or metadata) about the audio selected to be played and transmit and update a session event indicating new registration information to the media output unit 551.

In operation 517, the media output unit 551 may detect and store audio session information and the application name related to the audio played from the media session unit 553 based on the session event.

In process 530, the electronic device 501 may, if the media application 557 supports a casting service in which the server of the media application may directly transmit audio to the external electronic device, transmit the audio being played of the electronic device on the server to the external electronic device through the audio casting function.

Process 530 is described. In operation 531, the media application unit 557 may transmit a category filter indicating a media control category to the media router unit 555. The category filter may include CATEGORY_REMOTE_PLAYBACK information, CATEGORY_LIVE_AUDIO information, and/or CATEGORY_LIVE_VIDEO information. The CATEGORY_REMOTE_PLAYBACK information indicates support for remotely played media playback control, and is information indicating that a service capable of playback control on a remote device is registered. The CATEGORY_LIVE_AUDIO information indicates support for streaming live audio and may indicate information about a service that supports audio, e.g., a service that may support a TV and/or a speaker. The CATEGORY_LIVE_VIDEO information indicates video support and may indicate information about a service supporting video, e.g., a service capable of supporting a TV and/or a settop box.

In operation 533, the media output unit 551 may request a list of external electronic devices (e.g., a Wi-Fi speaker) supporting the media application along with the application name from the media router unit 555. According to an embodiment, the list of the external electronic devices may include a list of second external electronic devices including information about at least one second external electronic device including second type information capable of the audio casting function.

In operation 535, the media output unit 551 may receive the list of the external electronic devices (e.g., a Wi-Fi speaker) supporting the media application from the media router unit 555.

In operation 537, the media output unit 551 may identify one external electronic device 561 (e.g., a Wi-Fi speaker) selected by the user 550 from the list of the external electronic devices provided from the media output unit 551 from the user 550.

In operation 539, the media output unit 551 may transmit information about the external electronic device 561 (e.g., a Wi-Fi speaker) selected by the user to the media router unit 555.

In operation 541, the media router unit 555 may connect communication with the external electronic device 561 (e.g., a Wi-Fi speaker) using the communication module (e.g., the Wi-Fi communication module) of the electronic device and then transmit address information (e.g., URL information about the audio being played on the server of the media application) capable of the audio being played on the electronic device to the external electronic device 561 (e.g., a Wi-Fi speaker) to perform the audio casting function.

In operation 543, the media router unit 555 may transmit information about the external electronic device 561 (e.g., a Wi-Fi speaker) selected by the user to the media application 557.

In operation 545, the server of the media application 557 may transmit the audio being played on the electronic device to the external electronic device 561 (e.g., a Wi-Fi speaker) according to a request of the external electronic device 561 (e.g., a Wi-Fi speaker) based on the address information (e.g., the URL information about the audio being played on the media server) capable of receiving the audio being played on the electronic device so that the external electronic device 561 (e.g., a Wi-Fi speaker) may continuously play the audio being played on the electronic device.

In operation 547, the media application unit 557 may transmit update information about the external electronic device to inform the media router unit 555 of transmission of the audio to the external electronic device 561 (e.g., a Wi-Fi speaker).

In operation 549, the media router unit 555 may transmit the update information about the external electronic device to inform the media output unit 551 of transmission of the audio of the external electronic device 561 (e.g., a Wi-Fi speaker).

In process 550, the electronic device 501 may, if the media application does not support a casting service in which the server of the media application may directly transmit audio to the external electronic device, transmit the audio being played of the electronic device to the external electronic device through the audio mirroring function.

Process 550 is described. In operation 551, the media application unit 557 may transmit a category filter indicating a media control category to the media router unit 555. The category filter may include CATEGORY_REMOTE_PLAYBACK information, CATEGORY_LIVE_AUDIO information, and/or CATEGORY_LIVE_VIDEO information. The CATEGORY_REMOTE_PLAYBACK information indicates support for remotely played media playback control, and is information indicating that a service capable of playback control on a remote device is registered. The CATEGORY_LIVE_AUDIO information indicates support for streaming live audio and may indicate information about a service that supports audio, e.g., a service that may support a TV and/or a speaker. The CATEGORY_LIVE_VIDEO information indicates video support and may indicate information about a service supporting video, e.g., a service capable of supporting a TV and/or a settop box.

In operation 553, the media output unit 551 may request a list of external electronic devices (e.g., a Wi-Fi speaker) supporting the media application along with the audio mirroring request from the media router unit 555. According to an embodiment, the list of the external electronic devices may include a list of first external electronic devices including information about at least one first external electronic device including first type information capable of the audio mirroring function.

In operation 555, the media output unit 551 may receive the list of the external electronic devices (e.g., a Wi-Fi speaker) supporting the audio mirroring from the media router unit 555.

In operation 557, the media output unit 551 may identify one external electronic device 561 (e.g., a Wi-Fi speaker) selected by the user 550 from the list of the external electronic devices provided from the media output unit 551 from the user 550.

In operation 559, the media output unit 551 may transmit information about the external electronic device 561 (e.g., a Wi-Fi speaker) selected by the user to the media router unit 555.

In operation 561, the media router unit 555 may connect communication with the external electronic device 561 (e.g., a Wi-Fi speaker) using the communication module (e.g., the Wi-Fi communication module) of the electronic device.

In operation 563, the media router unit 555 may transmit information about the external electronic device 561 (e.g., a Wi-Fi speaker) selected by the user to the audio mirroring service unit 559.

In operation 565, the audio mirroring service unit 559 may separate the audio received from the media application unit 557 among various audios output from the electronic device, record the separated audio, and transmit the recorded audio to the external electronic device 561 (e.g., a Wi-Fi speaker) communicatively connected.

In operation 567, the audio mirroring service unit 559 may transmit update information about the external electronic device to inform the media router unit 555 of transmission of the audio to the external electronic device 561 (e.g., a Wi-Fi speaker).

In operation 569, the media router unit 555 may transmit the update information about the external electronic device to inform the media output unit 551 of transmission of the audio of the external electronic device 561 (e.g., a Wi-Fi speaker).

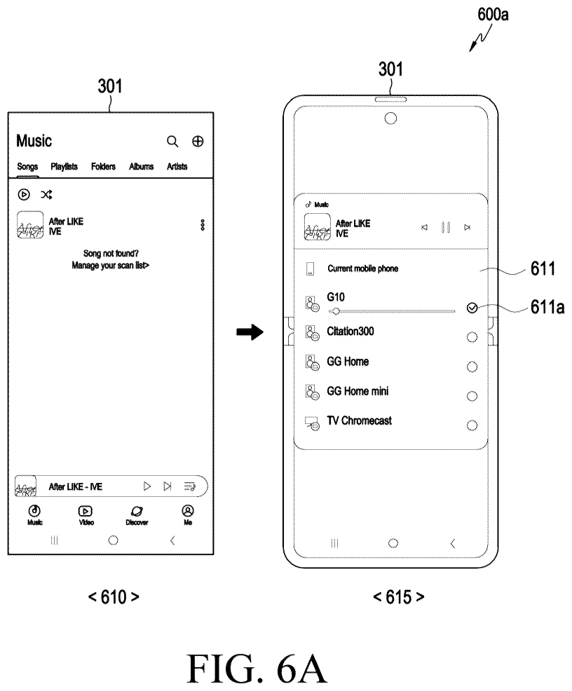

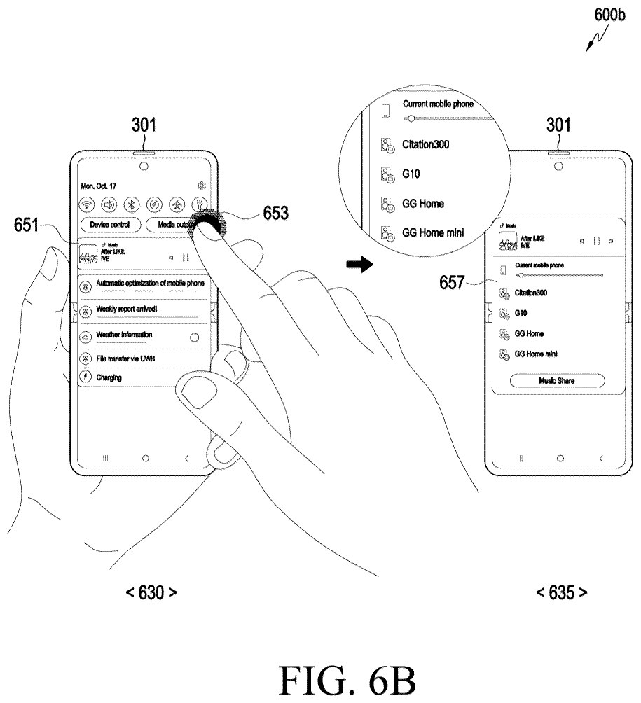

FIGS. 6A and 6B are views 600a and 600b illustrating an operation of providing a list of external electronic devices by an electronic device according to an embodiment.

Referring to FIG. 6A, as shown in screen <610>, the electronic device 301 (e.g., the electronic device 101 of FIG. 1, the electronic device 301 of FIG. 2, and/or the electronic device 301 of FIG. 3) may, while executing and displaying the media application to play the audio provided from the media application, identify the user's selection for transmitting the audio being played to the external electronic device.

As shown in screen <615>, the electronic device 301 (e.g., the electronic device 101 of FIG. 1, the electronic device 301 of FIG. 2, and/or the electronic device 301 of FIG. 3) may display a list 611 of external electronic devices including information about an external electronic device including a Wi-Fi speaker based on the user's selection for transmitting the audio being played to the external electronic device. The electronic device 301 may display an indicator 611a indicating that the external electronic device selected by the user from the list of the external electronic devices is playing audio while transmitting the audio being played on the electronic device through the audio mirroring function or the audio casting function to the external electronic device selected by the user from the list of the external electronic devices.

Referring to FIG. 6B, as shown in screen <630>, the electronic device 301 (e.g., the electronic device 101 of FIG. 1, the electronic device 301 of FIG. 2, and/or the electronic device 301 of FIG. 3) may, while providing the audio information currently being played through the media panel 651, identify the user's selection 653 on the media output button for transmitting the audio being played to the external electronic device.

As shown in screen <635>, the electronic device 301 (e.g., the electronic device 101 of FIG. 1, the electronic device 301 of FIG. 2, and/or the electronic device 301 of FIG. 3) may display a list 657 of external electronic devices including information about an external electronic device including a Wi-Fi speaker based on the user's selection on the media output button for transmitting the audio being played to the external electronic device.

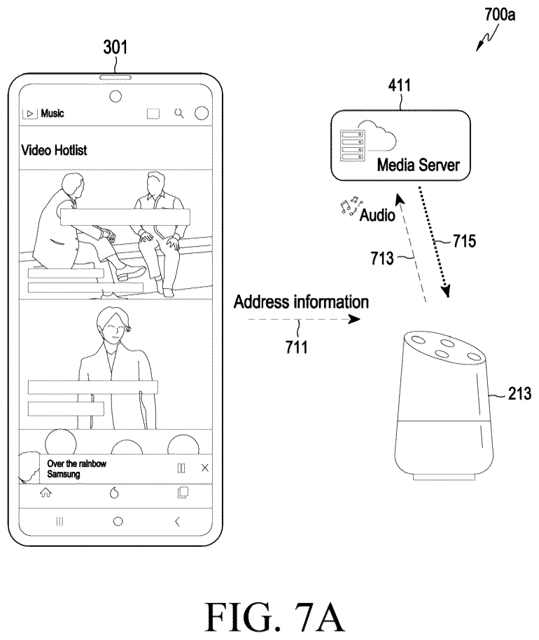

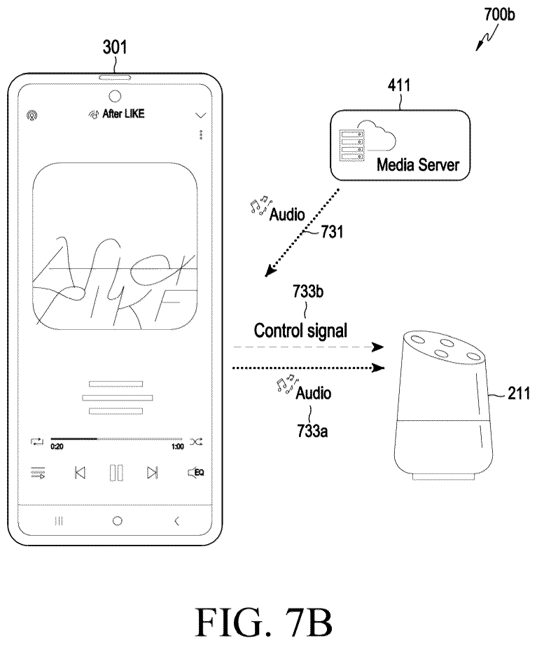

FIGS. 7A and 7B are views 700a and 700b illustrating an operation of transmitting an audio being played on an electronic device to an external electronic device according to an embodiment.

Referring to FIG. 7A, the electronic device 301 (e.g., the electronic device 101 of FIG. 1, the electronic device 301 of FIG. 2, and/or the electronic device 301 of FIG. 3) may, if identifying the user's selection for transmitting the audio being played to the external electronic device while executing the media application to play the audio provided from the media application, identify whether the media application supports a casting service in which the server of the media application may transmit audio to the external electronic device. If the media application supports the media application, the electronic device 301 may transmit, to the external electronic device, e.g., the Wi-Fi speaker 213, selected by the user, address information (e.g., the URL information about the audio being played on the server of the media application) capable of receiving audio through the communication module (e.g., the communication module 390 of FIG. 3) of the electronic device to perform the audio casting function receiving the audio being played from the server 355 of the media application (711). If the Wi-Fi speaker 213 requests audio from the server 355 of the media application based on the address information (e.g., the URL information about the audio being played on the server of the media application) received from the electronic device 201 (713), the server 355 of the media application may transmit the audio being transmitted to the electronic device 301 to the Wi-Fi speaker 213 (715).

Referring to FIG. 7B, the electronic device 301 (e.g., the electronic device 101 of FIG. 1, the electronic device 301 of FIG. 2, and/or the electronic device 301 of FIG. 3) may, if identifying the user's selection for transmitting the audio being played to the external electronic device while executing the media application to play the audio provided from the media application, identify whether the application providing the audio on the electronic device supports a casting service in which the server 355 of the media application may transmit audio to the external electronic device. If identifying that the media application does not support the casting service, the electronic device 301 may separate the audio provided from the media application among all the audios output from the electronic device 201, record the separated audio, and perform an audio mirroring function of transmitting the recorded audio to the external electronic device, e.g., the Wi-Fi speaker 211, selected by the user through the communication module (e.g., the communication module 390 of FIG. 3) of the electronic device 301 (733a). The electronic device 301 may transmit a control signal (e.g., http stream control) for transmitting audio in real-time through the audio mirroring function to the external electronic device 211 (733b).

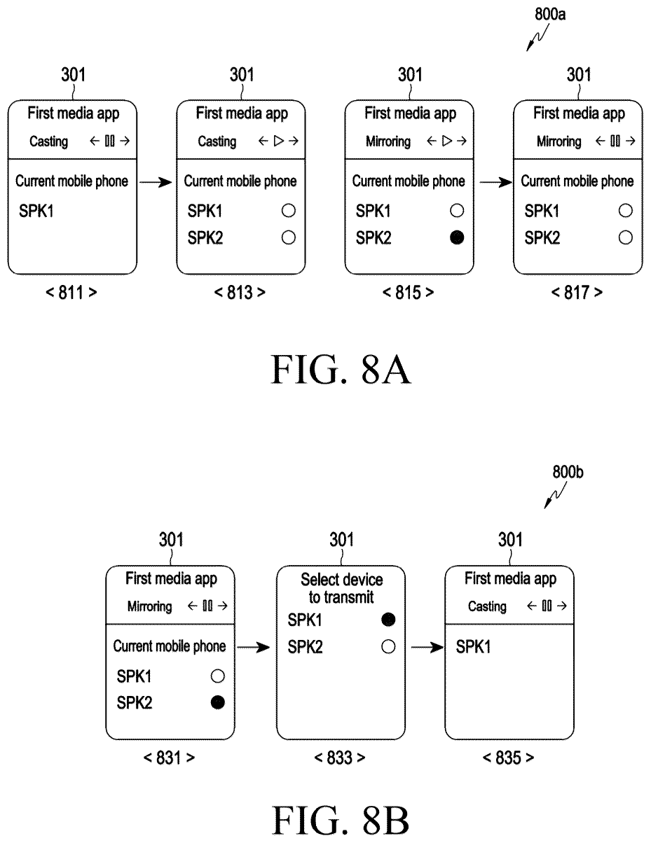

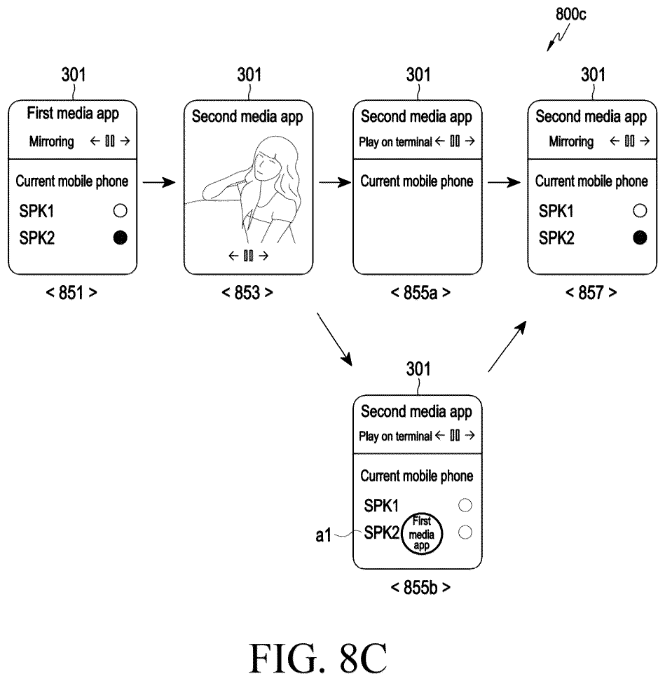

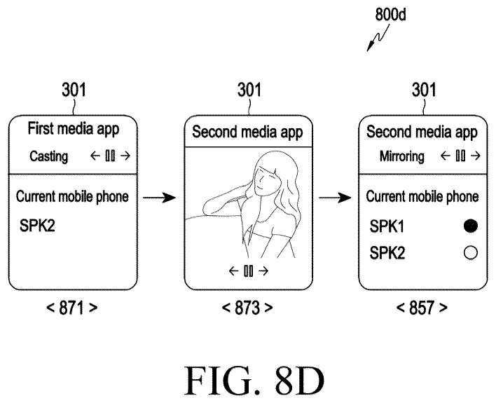

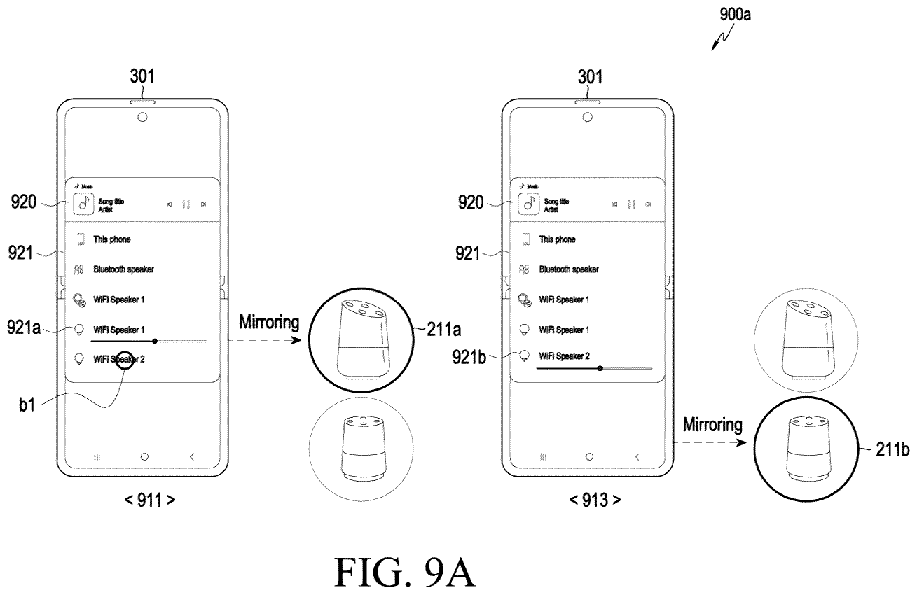

FIGS. 8A, 8B, 8C, and 8D are views 800a to 800d illustrating operations of transmitting an audio being played on an electronic device to an external electronic device according to an embodiment.

Referring to FIG. 8A, as shown in screen <811>, the electronic device 301 (e.g., the electronic device 101 of FIG. 1, the electronic device 301 of FIG. 2, and/or the electronic device 301 of FIG. 3) may display execution of a first media application capable of supporting a casting service based on the user's selection and display that a first audio is being transmitted to a first speaker SPK1 through the audio casting function while transmitting the first audio provided from the first media application to the first speaker SPK1 through the audio casting function.

As shown in screen <813>, the electronic device 301 (e.g., the electronic device 101 of FIG. 1, the electronic device 301 of FIG. 2, and/or the electronic device 301 of FIG. 3) may, if the audio casting function is stopped by the user, display a list of speakers SPK1 and SPK2 selectable by the user.

As shown in screen <815>, the electronic device 301 (e.g., the electronic device 101 of FIG. 1, the electronic device 301 of FIG. 2, and/or the electronic device 301 of FIG. 3) may identify the user's selection for playing the first audio transmitted from the first media application through the audio mirroring function on the second speaker SPK2.

As shown in screen <817>, the electronic device 301 (e.g., the electronic device 101 of FIG. 1, the electronic device 301 of FIG. 2, and/or the electronic device 301 of FIG. 3) may, if identifying the user's selection for playing the first audio on the second speaker SPK2 through the audio mirroring function, terminate the operation of transmitting the first audio provided from the first media application to the first speaker SPK1 through the audio casting function and transmit the first audio provided from the first media application to the second speaker SPK2 through the audio mirroring function.

Referring to FIG. 8B, as shown in screen <831>, the electronic device 301 (e.g., the electronic device 101 of FIG. 1, the electronic device 301 of FIG. 2, and/or the electronic device 301 of FIG. 3) may display execution of a first media application capable of supporting a casting service based on the user's selection and display the list of speakers SPK1 and SPK2 selectable by the user while transmitting the first audio provided from the first media application to the second speaker SPK2 through the audio mirroring function.

As shown in screen <833>, the electronic device 301 (e.g., the electronic device 101 of FIG. 1, the electronic device 301 of FIG. 2, and/or the electronic device 301 of FIG. 3) may identify the user's selection for playing the first audio provided from the first media application on the first speaker SPK1 through the audio casting function.

As shown in screen <835>, the electronic device 301 (e.g., the electronic device 101 of FIG. 1, the electronic device 301 of FIG. 2, and/or the electronic device 301 of FIG. 3) may, if identifying the user's selection for playing the first audio on the second speaker SPK2 through the audio casting function, terminate the operation of transmitting the first audio provided from the first media application to the first speaker SPK1 through the audio mirroring function and transmit the first audio provided from the first media application to the second speaker SPK2 through the audio casting function. The electronic device 301 may display that the first audio is being played on the first speaker SPK1 through the audio casting function while transmitting the first audio provided from the first media application to the first speaker SPK1 through the audio casting function.

Referring to FIG. 8C, as shown in screen <851>, the electronic device 301 (e.g., the electronic device 101 of FIG. 1, the electronic device 301 of FIG. 2, and/or the electronic device 301 of FIG. 3) may display execution of the first media application based on the user's selection and display the list of speakers SPK1 and SPK2 selectable by the user while transmitting the first audio provided from the first media application to the second speaker SPK2 through the audio mirroring function.

As shown in screen <853>, the electronic device 301 (e.g., the electronic device 101 of FIG. 1, the electronic device 301 of FIG. 2, and/or the electronic device 301 of FIG. 3) may, while transmitting the first audio provided from the first media application to the second speaker SPK2, display execution of the second media application and play the second audio provided from the second media application on the electronic device 301.

As shown in screen <855a>, the electronic device 301 (e.g., the electronic device 101 of FIG. 1, the electronic device 301 of FIG. 2, and/or the electronic device 301 of FIG. 3) may display that the second audio provided from the second media application is currently being played on the electronic device 301 or, as shown in screen <855b>, display (a1) that the second audio provided from the second media application is currently being played on the electronic device 301, and the first audio provided from the first media application is currently being played on the second speaker.

As shown in screen <857>, the electronic device 301 (e.g., the electronic device 101 of FIG. 1, the electronic device 301 of FIG. 2, and/or the electronic device 301 of FIG. 3) may, if identifying a selection of transmission of the second audio provided from the second media application to the first speaker SPK1 through the audio mirroring function, terminate the operation of transmitting the first audio provided from the first media application to the second speaker SPK2 through the audio mirroring function and transmit the second audio provided from the second media application to the first speaker SPK1 through the audio mirroring function.

Referring to FIG. 8D, as shown in screen <871>, the electronic device 301 (e.g., the electronic device 101 of FIG. 1, the electronic device 301 of FIG. 2, and/or the electronic device 301 of FIG. 3) may display execution of a first media application capable of supporting a casting service based on the user's selection and display that the first audio is being played on the second speaker SPK2 through the audio casting function while transmitting the first audio provided from the first media application to the second speaker SPK2 through the audio casting function.

As shown in screen <873>, the electronic device 301 (e.g., the electronic device 101 of FIG. 1, the electronic device 301 of FIG. 2, and/or the electronic device 301 of FIG. 3) may, while transmitting the first audio provided from the first media application to the second speaker SPK2, display execution of the second media application and play the second audio provided from the second media application on the electronic device.

As shown in screen <875>, the electronic device 301 (e.g., the electronic device 101 of FIG. 1, the electronic device 301 of FIG. 2, and/or the electronic device 301 of FIG. 3) may, if identifying a selection of transmission of the second audio provided from the second media application to the first speaker SPK1 through the audio mirroring function while transmitting the first audio provided from the first media application to the second speaker SPK2 through the audio casting function, transmit the second audio provided from the second media application to the first speaker SPK1 through the audio mirroring function. The electronic device 301 may, while transmitting the first audio provided from the first media application to the second speaker SPK2 through the audio casting function, transmit the second audio provided from the second media application to the first speaker SPK1 through the audio mirroring function.

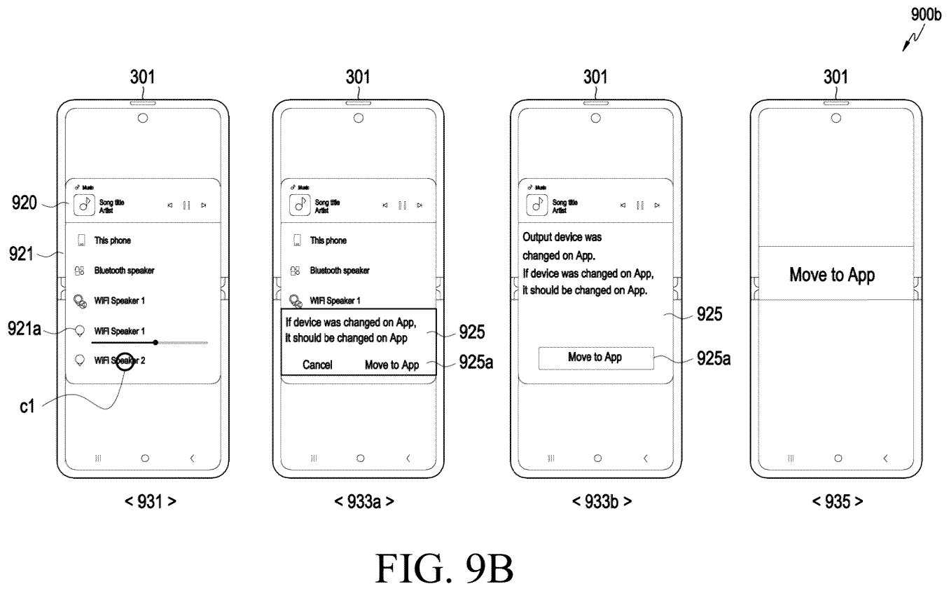

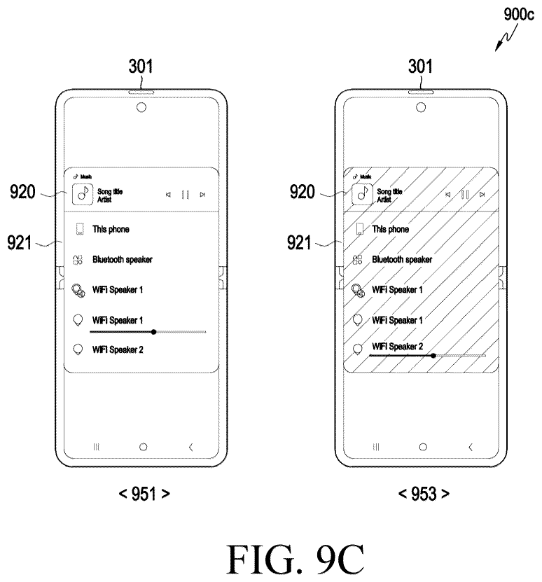

FIGS. 9A, 9B, and 9C are views 900a to 900c illustrating operations of transmitting an audio being played on an electronic device to an external electronic device according to an embodiment.

Referring to FIG. 9A, as shown in screen <911>, the electronic device 301 (e.g., the electronic device 101 of FIG. 1, the electronic device 301 of FIG. 2, and/or the electronic device 301 of FIG. 3) may, while displaying a media panel 920 providing buttons (e.g., play/pause buttons and previous/next song play buttons) capable of controlling audio and information about the audio being played on the electronic device, display a list 921 of external electronic devices including information about at least one first external electronic device including first type information capable of the audio mirroring function and information about the second external electronic device including second type information capable of the audio casting function based on the user's selection. The electronic device 301 may, if identifying a selection of transmission of the audio being played on the electronic device to the first external electronic device (e.g., a first external speaker) selected by the user from the list of the external electronic devices, transmit the audio being played on the electronic device to the first external electronic device 211a through the audio mirroring function. The electronic device 301 may display (921a) that audio is being to the first external electronic device 211a through the audio mirroring function on the list 921 of the external electronic devices.

As shown in screen <913>, the electronic device 301 (e.g., the electronic device 101 of FIG. 1, the electronic device 301 of FIG. 2, and/or the electronic device 301 of FIG. 3) may, if identifying a selection (b1) of transmission of the audio being played on the electronic device to the first external electronic device 211a selected by the user from the list of the external electronic devices through the audio mirroring function while transmitting the audio being played on the electronic device to the first external electronic device 211a through the audio mirroring function, terminate the operation of transmitting the audio being played on the electronic device to the first external electronic device 211b through the audio mirroring function and transmit the audio being played on the electronic device to the first external electronic device 211b through the audio mirroring function. The electronic device 301 may display (921b) that audio is being transmitted to the second external electronic device 211b through the audio mirroring function on the list 921 of the external electronic devices.

Referring to FIG. 9B, as shown in screen <931>, the electronic device 301 (e.g., the electronic device 101 of FIG. 1, the electronic device 301 of FIG. 2, and/or the electronic device 301 of FIG. 3) may, while displaying a media panel 920 providing buttons (e.g., play/pause buttons and previous/next song play buttons) capable of controlling audio and information about the audio being played on the electronic device, display a list 921 of external electronic devices including information about at least one first external electronic device including first type information capable of the audio mirroring function and information about the second external electronic device including second type information capable of the audio casting function based on the user's selection. The electronic device 301 may, if identifying a selection of transmission of the audio being played on the electronic device 301 to the first external electronic device (e.g., a first external speaker) selected by the user from the list of the external electronic devices through the audio mirroring function, transmit the audio being played on the electronic device to the first external electronic device through the audio mirroring function and display (921a) that audio is being transmitted to the first external electronic device through the audio mirroring function on the list 921 of the external electronic devices.

As shown in screen <933a> or screen <933b>, the electronic device 301 (e.g., the electronic device 101 of FIG. 1, the electronic device 301 of FIG. 2, and/or the electronic device 301 of FIG. 3)

may, if identifying a selection of transmission of the audio being played on the electronic device 301 to the second external electronic device selected by the user from the list of the external electronic devices through the audio casting function while transmitting the audio being played on the electronic device to the first external electronic device through the audio mirroring function, display a popup window 925 including a button 925a capable of moving to the media application together with a message indicating that it should be moved to the media application providing the audio being played on the electronic device to perform the audio casting function.

As shown in screen <933>, the electronic device 301 (e.g., the electronic device 101 of FIG. 1, the electronic device 301 of FIG. 2, and/or the electronic device 301 of FIG. 3) may display execution of the media application by moving to the media application based on a selection of the button 925a capable of moving to the media application provided from the popup window 925.

Referring to FIG. 9C, in screen <951>, the electronic device 301 (e.g., the electronic device 101 of FIG. 1, the electronic device 301 of FIG. 2, and/or the electronic device 301 of FIG. 3) may make a visual distinction between when indicating that audio is being played on the second external electronic device through the audio casting function and when indicating that audio is being played on the first external electronic device (e.g., a first external speaker) selected by the user through the audio mirroring function while displaying the media panel 920 providing the buttons (e.g., play/pause buttons and previous/next song play buttons) capable of controlling audio and information about the audio being played on the electronic device. For example, it may be indicated that audio is being played on the first external electronic device through the audio mirroring function to be visually distinct from when playing audio on the second external electronic device through the audio casting function using colors and/or an indicator.

In screen <953>, the electronic device 301 (e.g., the electronic device 101 of FIG. 1, the electronic device 301 of FIG. 2, and/or the electronic device 301 of FIG. 3) may make a visual distinction between when indicating that audio is being played on the first external electronic device through the audio mirroring function and when indicating that audio is being played on the second external electronic device (e.g., a second external speaker) selected by the user through the audio casting function while displaying the media panel 920. For example, it may be indicated that audio is being played on the second external electronic device through the audio casting function to be visually distinct from when playing audio on the first external electronic device through the audio mirroring function using colors and/or an indicator. The electronic device 301 may output a message indicating that another media application may be used while playing audio on the second external electronic device through the audio casting function.

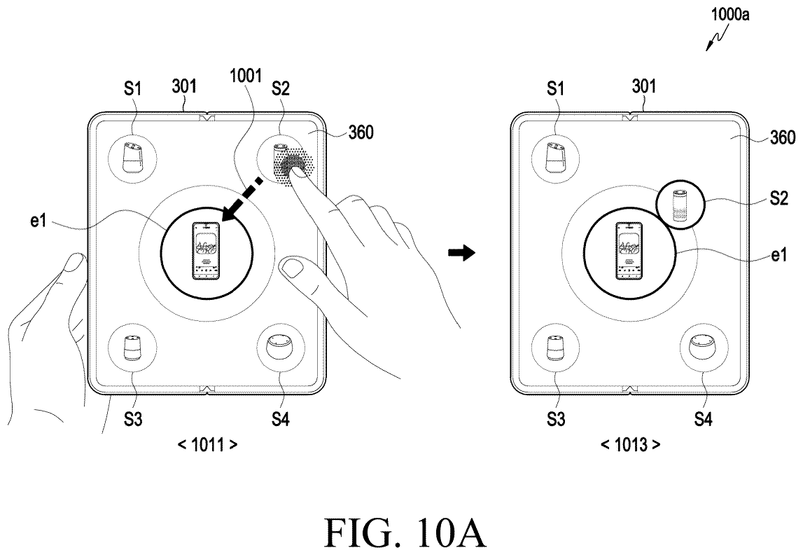

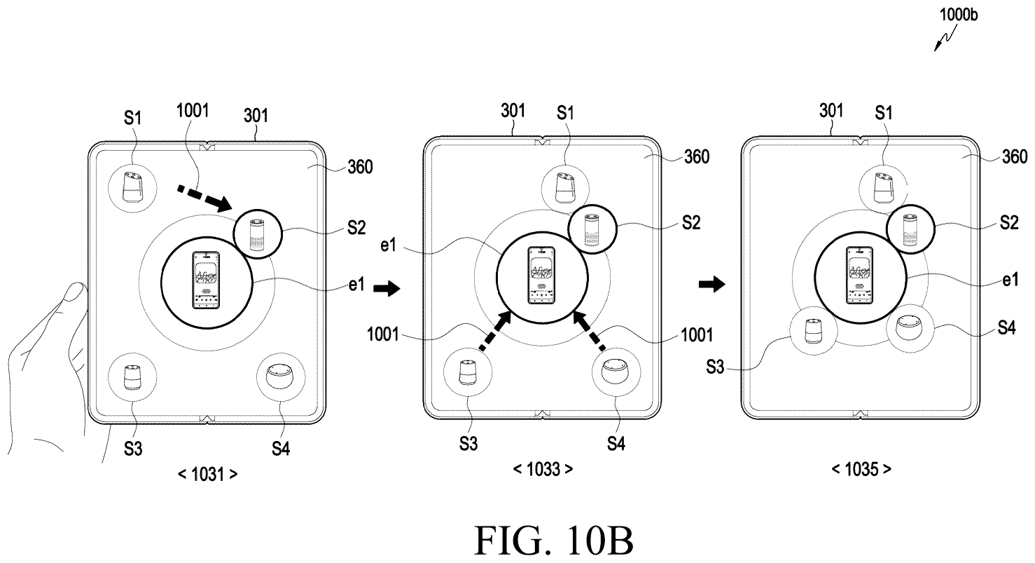

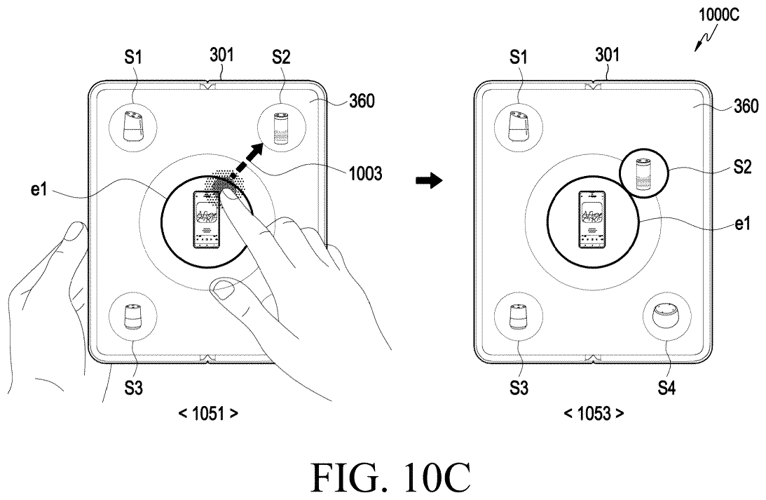

FIGS. 10A, 10B, and 10C are views 1000a to 1000c illustrating operations of selecting an external electronic device for transmitting an audio being played on an electronic device according to an embodiment.

Referring to FIG. 10A, as shown in screen <1011>, the electronic device 301 (e.g., the electronic device 101 of FIG. 1, the electronic device 301 of FIG. 2, and/or the electronic device 301 of FIG. 3) may, when displaying a list of external electronic devices based on the user's selection while playing audio on the electronic device, control the display 360 (e.g., the display 360 of FIG. 3) of the electronic device to display a first icon el indicating the electronic device and a plurality of speaker icons s1, s2, s3, and s4 respectively indicating a plurality of external electronic devices, e.g., a plurality of Wi-Fi speakers. The electronic device 301 may identify that the second speaker icon s2 is moved near the first icon el based on the user's gesture (e.g., drag-and-drop) 1001 after the second speaker icon s2 is selected among the plurality of speaker icons.

As shown in screen <1013>, the electronic device 301 (e.g., the electronic device 101 of FIG. 1, the electronic device 301 of FIG. 2, and/or the electronic device 301 of FIG. 3) may, if the second speaker icon s2 among the plurality of speaker icons is moved and displayed near the first icon e1, transmit the audio being played on the electronic device to the second Wi-Fi speaker indicated by the second speaker icon s2 using the audio mirroring function or the audio casting function.

Referring to FIG. 10B, as shown in screen <1031>, the electronic device 301 (e.g., the electronic device 101 of FIG. 1, the electronic device 301 of FIG. 2, and/or the electronic device 301 of FIG. 3) may identify that the first speaker icon s1 is moved near the first icon el based on the user's gesture (e.g., drag-and-drop) 1001 after the first speaker icon s1 is selected among the plurality of speaker icons within a predetermined time while the second speaker icon s2 among the plurality of speaker icons s1, s2, s3, and s4 is moved and displayed near the first icon el.

In screen <1033>, the electronic device 301 (e.g., the electronic device 101 of FIG. 1, the electronic device 301 of FIG. 2, and/or the electronic device 301 of FIG. 3) may identify that the third speaker icon s3 is moved near the first icon el based on the user's gesture (e.g., drag-and-drop) 1001 after the third speaker icon s3 is selected among the plurality of speaker icons within a predetermined time, and the fourth speaker icon s4 is moved near the first icon el based on the user's gesture (e.g., drag-and-drop) 1001 after the fourth speaker icon s4 is selected among the plurality of second icons while the first speaker icon s1 and the second speaker icon s2 among the plurality of speaker icons s1, s2, s3, and s4 are moved and displayed near the first icon e1.

As shown in screen <1035>, the electronic device 301 (e.g., the electronic device 101 of FIG. 1, the electronic device 301 of FIG. 2, and/or the electronic device 301 of FIG. 3) may, if the plurality of speaker icons s1, s2, s3, and s4 are moved and displayed near the first icon e1, transmit the audio being played on the electronic device to the plurality of Wi-Fi speakers respectively corresponding to the plurality of speaker icons s1, s2, s3, and s4 using the audio mirroring function or the audio casting function.

Referring to FIG. 10C, as shown in screen <1051>, the electronic device 301 (e.g., the electronic device 101 of FIG. 1, the electronic device 301 of FIG. 2, and/or the electronic device 301 of FIG. 3) may, when displaying a list of external electronic devices based on the user's selection while playing audio on the electronic device, control the display 360 (e.g., the display 360 of FIG. 3) of the electronic device to display a first icon e1 indicating the electronic device and a plurality of speaker icons s1, s2, s3, and s4 respectively indicating a plurality of external electronic devices, e.g., a plurality of Wi-Fi speakers. The electronic device 301 may identify that the first icon el is moved near the second speaker icon s2 among the plurality of speaker icons based on the user's gesture (e.g., drag-and-drop) 1001 after the first icon e1 is selected.

As shown in screen <1013>, the electronic device 301 (e.g., the electronic device 101 of FIG. 1, the electronic device 301 of FIG. 2, and/or the electronic device 301 of FIG. 3) may, if the first icon e1 is moved and displayed near the second speaker icon s2 among the plurality of speaker icons, transmit the audio being played on the electronic device to the Wi-Fi speaker indicated by the second speaker icon s2 using the audio mirroring function or the audio casting function.

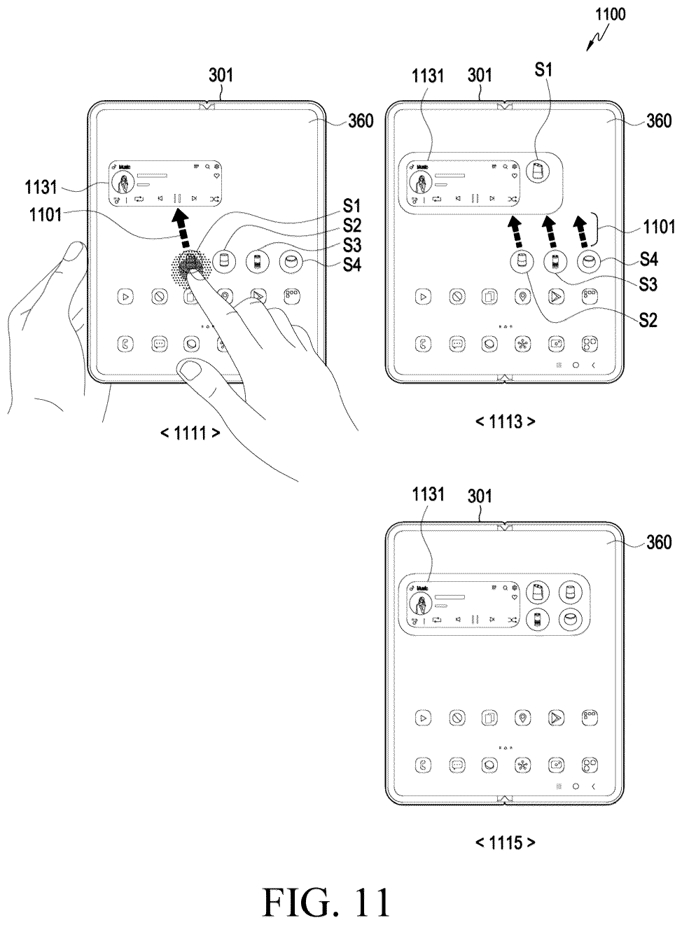

FIG. 11 is a view 1100 illustrating operations of selecting an external electronic device for transmitting an audio being played on an electronic device according to an embodiment.

Referring to FIG. 11, as shown in screen <1111>, the electronic device 301 (e.g., the electronic device 101 of FIG. 1, the electronic device 301 of FIG. 2, and/or the electronic device 301 of FIG. 3) may display buttons (e.g., play/pause buttons and previous/next song play buttons) capable of controlling audio and information about the audio being played on the electronic device as a widget 1131 while playing the audio on the electronic device. The electronic device 301 may, when displaying a list of external electronic devices based on the user's selection while displaying the buttons capable of controlling audio and the audio information as the widget, control the display 360 (e.g., the display 360 of FIG. 3) of the electronic device to display a plurality of speaker icons s1, s2, s3, and s4 respectively indicating a plurality of external electronic devices, e.g., a plurality of Wi-Fi speakers, in a partial area. The electronic device 301 may identify that the first speaker icon s1 is moved to the widget 1131 based on the user's gesture (e.g., drag-and-drop) 1101 after the first speaker icon s1 is selected among the plurality of speaker icons s1, s2, s3, and s4.

As shown in screen <1113>, the electronic device 301 (e.g., the electronic device 101 of FIG. 1, the electronic device 301 of FIG. 2, and/or the electronic device 301 of FIG. 3) may identify that, while the first speaker icon s1 is positioned and displayed in the widget 1131, within a predetermined time, the electronic device 301 (e.g., the electronic device 101 of FIG. 1, the second speaker icon s2 is moved to the widget 1131 based on the user's gesture (e.g., drag-and-drop) 1001 after the second speaker icon s2 is selected among the plurality of speaker icons, the third speaker icon s3 is moved to the widget 1131 based on the user's gesture (e.g., drag-and-drop) 1101 after the third speaker icon s3 is selected among the plurality of speaker icons, and the fourth speaker icon s4 is moved to the widget 1131 based on the user's gesture (e.g., drag-and-drop) 1101 after the fourth speaker icon s4 is selected among the plurality of speaker icons.

As shown in screen <1115>, the electronic device 301 (e.g., the electronic device 101 of FIG. 1, the electronic device 301 of FIG. 2, and/or the electronic device 301 of FIG. 3) may, if the plurality of speaker icons s1, s2, s3, and s4 are moved and displayed in the widget 1131, transmit the audio being played on the electronic device to the plurality of Wi-Fi speakers respectively indicated by the plurality of speaker icons.

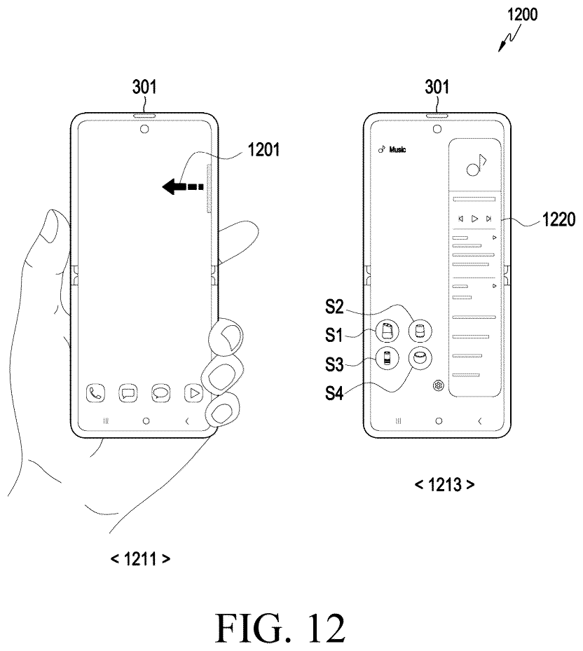

FIG. 12 is a view 1200 illustrating operations of selecting an external electronic device for transmitting an audio being played on an electronic device according to an embodiment.

Referring to FIG. 12, as shown in screen <1211>, the electronic device 301 (e.g., the electronic device 101 of FIG. 1, the electronic device 301 of FIG. 2, and/or the electronic device 301 of FIG. 3) may identify a selection for displaying an edge panel displaying a function set by the user if detecting the user's move gesture toward the center from a side surface of the electronic device while playing the audio on the electronic device.

As shown in screen <1213>, the electronic device 301 (e.g., the electronic device 101 of FIG. 1, the electronic device 301 of FIG. 2, and/or the electronic device 301 of FIG. 3) may display audio information and buttons capable of controlling audio on the edge panel 1220 when functions providable by the buttons capable of controlling audio and the audio information are set on the edge panel. The electronic device may, while the audio information and the buttons capable of controlling audio are displayed on the edge panel 1220, control the display 360 of the electronic device to display a plurality of speaker icons s1, s2, s3, and s4 indicating the plurality of Wi-Fi speakers selectable by the user in a partial area.

According to an embodiment, an electronic device (101 of FIG. 1; 301 of FIG. 2; 301 of FIG. 3) may comprise a display (160 of FIG. 1; 360 of FIG. 3), a communication module (190 of FIG. 1; 390 of FIG. 3), and a processor (120 of FIG. 1; 320 of FIG. 3).

According to an embodiment, the processor (120 of FIG. 1; 320 of FIG. 3) may perform an audio mirroring function of, while an audio is being played on the electronic device, if a selection for transmitting the audio being played to an external electronic device is identified, separating the audio being played from an audio output from the electronic device, recording the separated audio, and transmitting the recorded audio to the external electronic device through the communication module.

According to an embodiment, the processor (120 of FIG. 1; 320 of FIG. 3) may identify whether a media application providing the audio on the electronic device supports a casting service in which a server of the media application transmits an audio to the external electronic device.

According to an embodiment, the processor (120 of FIG. 1; 320 of FIG. 3) may, if the media application does not support the casting service, perform the audio mirroring function of transmitting the audio being played to the external electronic device.

According to an embodiment, the processor (120 of FIG. 1; 320 of FIG. 3) may, if the media application providing the audio supports the casting service, transmit, to the external electronic device, address information capable of receiving the audio through the communication module to perform an audio casting function of receiving the audio being played from the server of the media application.

According to an embodiment, the processor (120 of FIG. 1; 320 of FIG. 3) may, while the audio is being played on the electronic device, if the selection for transmitting the audio being played to the external electronic device, search for at least one external electronic device communicatively connected through the communication module.

According to an embodiment, the processor (120 of FIG. 1; 320 of FIG. 3) may control the display to display a list of external electronic devices including the searched at least one external electronic device and perform the audio mirroring function of transmitting the audio being played through an external electronic device selected from the list of the external electronic devices.

According to an embodiment, the processor (120 of FIG. 1; 320 of FIG. 3) may identify whether the media application providing the audio or the external electronic device supports the audio mirroring function.

According to an embodiment, the processor (120 of FIG. 1; 320 of FIG. 3) may, if the media application providing the audio or the external electronic device supports the audio mirroring function, perform the audio mirroring function of transmitting the audio being played to the external electronic device.

According to an embodiment, the processor (120 of FIG. 1; 320 of FIG. 3) may, if a selection of the audio casting function is identified while the audio being played is transmitted to a first external electronic device among at least one external electronic device through the audio mirroring function, identify whether the media application providing the audio supports the casting service in which a server of the media application transmits the audio to the external electronic device.

According to an embodiment, the processor (120 of FIG. 1; 320 of FIG. 3) may, if the media application supports the casting service, transmit, to a second external electronic device among the at least one external electronic device, address information capable of receiving the audio through the communication module to receive the audio being played from the server of the media application through the audio casting function.

According to an embodiment, the processor (120 of FIG. 1; 320 of FIG. 3) may, while a first audio provided from a first media application through the audio mirroring function is transmitted to a first external electronic device among the at least one external electronic device, if a selection of the audio mirroring function for a second audio provided from a second media application is identified, perform the audio mirroring function of transmitting the second audio to a second external electronic device among the at least one external electronic device.

According to an embodiment, the processor (120 of FIG. 1; 320 of FIG. 3) may, while a server of a first media application transmits a first audio to a second external electronic device among at least one external electronic device through the audio casting function, if a selection of the audio mirroring function for a second audio provided from a second media application is identified, perform the audio mirroring function of transmitting the second audio from the electronic device to a first external electronic device among the at least one external electronic device.

According to an embodiment, the processor (120 of FIG. 1; 320 of FIG. 3) may, while the audio being played is transmitted to a first external electronic device among at least one external electronic device through the audio mirroring function, if a selection for changing the audio being played to a second external electronic device among the at least one external electronic device through the audio casting function, control the display to display a button for moving to the media application providing the audio to change to the external electronic device.

According to an embodiment, the processor (120 of FIG. 1; 320 of FIG. 3) may display a first icon indicating the electronic device and at least one second icon indicating at least one external electronic device.

According to an embodiment, the processor (120 of FIG. 1; 320 of FIG. 3) may identify a second icon selected to be related to the first icon through a gesture among the at least one second icon.

According to an embodiment, the processor (120 of FIG. 1; 320 of FIG. 3) may transmit the audio being played to an external electronic device corresponding to the identified second icon through the audio mirroring function or the audio casting function.

According to an embodiment, an electronic device (101 of FIG. 1; 301 of FIG. 2; 301 of FIG. 3) may comprise a communication module (190 of FIG. 1; 390 of FIG. 3) and a processor (120 of FIG. 1; 320 of FIG. 3).

According to an embodiment, the processor (120 of FIG. 1; 320 of FIG. 3) may receive type information for receiving an audio from a plurality of external electronic devices communicatively connected through the communication module.

According to an embodiment, the processor (120 of FIG. 1; 320 of FIG. 3) may, while the electronic device plays a first audio provided from a first media application, transmit the first audio through an audio mirroring function to a first external electronic device where the type information for the audio reception includes first type information capable of an audio mirroring function among the plurality of external electronic devices.

According to an embodiment, the processor (120 of FIG. 1; 320 of FIG. 3) may play a second audio provided from a second media application, on the electronic device, while transmitting the first audio to the first external electronic device through the audio mirroring function.

According to an embodiment, the processor (120 of FIG. 1; 320 of FIG. 3) may, while the electronic device plays the second audio provided from the second media application, transmit the second audio, by using the audio casting function, to a second external electronic device where the type information for the audio reception includes second type information capable of the audio casting function among the plurality of external electronic devices.

According to an embodiment, the processor (120 of FIG. 1; 320 of FIG. 3) may perform the audio mirroring function of separating the first audio being played on the electronic device from an audio output from the electronic device, recording the separated first audio, and transmitting the recorded first audio to the first external electronic device through the communication module.

According to an embodiment, the processor (120 of FIG. 1; 320 of FIG. 3) may transmit, to the second external electronic device, address information capable of receiving the second audio through the communication module to perform an audio casting function of receiving the second audio being played on the electronic device from a server of the second media application.

According to an embodiment, a method for transmitting an audio to an external electronic device by an electronic device (101 of FIG. 1; 301 of FIG. 2; 301 of FIG. 3), may comprise playing an audio on the electronic device.

According to an embodiment, the method may comprise performing an audio mirroring function of, if a selection for transmitting the audio being played to an external electronic device is identified, separating the audio being played from an audio output from the electronic device, recording the separated audio, and transmitting the recorded audio to the external electronic device through a communication module (190 of FIG. 1; 390 of FIG. 3) of the electronic device.

According to an embodiment, the method may comprise identifying whether a media application providing the audio on the electronic device supports a casting service in which a server of the media application transmits an audio to the external electronic device.

According to an embodiment, the method may comprise, if the media application does not support the casting service, performing the audio mirroring function of transmitting the audio being played to the external electronic device.

According to an embodiment, the method may comprise, if the media application providing the audio supports the casting service, transmitting, to the external electronic device, address information capable of receiving the audio through the communication module to perform an audio casting function of receiving the audio being played from the server of the media application.

According to an embodiment, the method may comprise, while the audio is being played on the electronic device, if the selection for transmitting the audio being played to the external electronic device, searching for at least one external electronic device communicatively connected through the communication module.

According to an embodiment, the method may comprise controlling a display of the electronic device to display a list of external electronic devices including information about the searched at least one external electronic device.

According to an embodiment, the method may comprise performing the audio mirroring function of transmitting the audio being played to an external electronic device selected from the list of the external electronic devices.

According to an embodiment, the method may comprise identifying whether the media application providing the audio or the external electronic device supports the audio mirroring function.

According to an embodiment, the method may comprise, if the media application providing the audio or the external electronic device supports the audio mirroring function, performing the audio mirroring function of transmitting the audio being played to the external electronic device.

According to an embodiment, the method may comprise, if a selection of the audio casting function is identified while the audio being played is transmitted to a first external electronic device among at least one external electronic device through the audio mirroring function, identifying whether the media application providing the audio supports the casting service in which a server of the media application transmits the audio to the external electronic device.

According to an embodiment, the method may comprise, if the media application supports the casting service, transmitting, to a second external electronic device among the at least one external electronic device, address information capable of receiving the audio through the communication module to receive the audio being played from the server of the media application through the audio casting function.

According to an embodiment, the method may comprise, while a first audio provided from a first media application through the audio mirroring function is output to a first external electronic device among the at least one external electronic device, if a selection of the audio mirroring function for a second audio provided from a second media application is identified, performing the audio mirroring function of transmitting the second audio to a second external electronic device among the at least one external electronic device.

According to an embodiment, the method may comprise, while a server of a first media application transmits a first audio to a second external electronic device among at least one external electronic device through the audio casting function, if a selection of the audio mirroring function for a second audio provided from a second media application is identified, performing the audio mirroring function of transmitting the second audio from the electronic device to a first external electronic device among the at least one external electronic device.

According to an embodiment, the method may comprise, while the audio being played is transmitted to a first external electronic device among at least one external electronic device through the audio mirroring function, if a selection for changing the audio being played to a second external electronic device among the at least one external electronic device through the audio casting function, controlling the display of the electronic device to display a button for moving to the media application providing the audio to change to the external electronic device.

According to an embodiment, the method may comprise may display a first icon indicating the electronic device and at least one second icon indicating at least one external electronic device.

According to an embodiment, the method may comprise identifying a second icon selected to be related to the first icon through a gesture among the at least one second icon.

According to an embodiment, the method may comprise transmitting the audio being played to an external electronic device corresponding to the identified second icon through the audio mirroring function or the audio casting function.

According to an embodiment, a method for transmitting an audio to an external electronic device by an electronic device (101 of FIG. 1; 301 of FIG. 2; 301 of FIG. 3) may comprise receiving type information for receiving an audio from a plurality of external electronic devices communicatively connected through a communication module (190 of FIG. 1; 390 of FIG. 3) of the electronic device.

According to an embodiment, the method may comprise, while the electronic device plays a first audio provided from a first media application, transmitting the first audio through an audio mirroring function to a first external electronic device where the type information for the audio reception includes first type information capable of an audio mirroring function among the plurality of external electronic devices.

According to an embodiment, the method may comprise playing a second audio provided from a second media application, on the electronic device, while transmitting the first audio to the first external electronic device through the audio mirroring function.

According to an embodiment, the method may comprise, while the electronic device plays the second audio provided from the second media application, transmitting the second audio, by using the audio casting function, to a second external electronic device where the type information for the audio reception includes second type information capable of the audio casting function among the plurality of external electronic devices.

According to an embodiment, the method may comprise performing the audio mirroring function of separating the first audio being played on the electronic device from an audio output from the electronic device, recording the separated first audio, and transmitting the recorded first audio to the first external electronic device through the communication module.

According to an embodiment, the method may comprise transmitting, to the second external electronic device, address information capable of receiving the second audio through the communication module to perform an audio casting function of receiving the second audio being played on the electronic device from a server of the second media application.

The electronic device according to an embodiment of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application- specific integrated circuit (ASIC).

An embodiment of the disclosure may be implemented as software (e.g., the program 140) including one or more instructions that are stored in a storage medium (e.g., internal memory 136 or external memory 138) that is readable by a machine (e.g., the electronic device 101 or the electronic device 301). For example, a processor (e.g., the processor 520) of the machine (e.g., the electronic device 301) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

According to an embodiment of the disclosure, in a non-transitory storage medium storing instructions, the instructions may be configured to, when executed by an electronic device, enable the electronic device to perform at least one operation. The at least one operation may comprise playing an audio on the electronic device and performing an audio mirroring function of, if a selection for transmitting the audio being played to an external electronic device is identified, separating the audio being played from an audio output from the electronic device, recording the separated audio, and transmitting the recorded audio to the external electronic device through a communication module of the electronic device.

According to an embodiment of the disclosure, in a non-transitory storage medium storing instructions, the instructions may be configured to, when executed by an electronic device, enable the electronic device to perform at least one operation. The at least one operation may comprise receiving type information for receiving an audio from a plurality of external electronic devices communicatively connected through a communication module of the electronic device, while the electronic device plays a first audio provided from a first media application, transmitting the first audio through the audio mirroring function to a first external electronic device, where the type information for the audio reception includes first type information capable of the audio mirroring function, among the plurality of external electronic devices, while transmitting the first audio to the first external electronic device through the audio mirroring function, playing a second audio provided from a second media application by the electronic device, and while the electronic device plays the second audio provided from the second media application, transmitting the second audio using the audio casting function, to a second external electronic device where the type information for the audio reception includes second type information capable of the audio casting function among the plurality of external electronic devices.

What is claimed is:

1. An electronic device, comprising:
a display;
a communication module;
at least one processor; and
memory storing instructions that, when executed by the at least one processor individually or collectively, cause the electronic device to:
perform an audio mirroring function including, in a state in which an audio is being played on the electronic device, based on identifying a selection for transmitting the audio being played to at least one external electronic device, separating the audio being played from an audio output of the electronic device, recording the separated audio, and transmitting the recorded audio to the at least one external electronic device through the communication module.

2. The electronic device of claim 1, wherein the instructions, when executed by the at least one processor individually or collectively, further cause the electronic device to:
identify whether a media application providing the audio on the electronic device supports a casting service in which a server of the media application is configured to be able to transmit the audio to the at least one external electronic device; and
based on the media application not supporting the casting service, perform the audio mirroring function to transmit the audio being played to the at least one external electronic device.

3. The electronic device of claim 2, wherein the instructions, when executed by the at least one processor individually or collectively, further cause the electronic device to:
based on the media application supporting the casting service, transmit, to the at least one external electronic device, address information that enables the at least one external electronic device to receive the audio through the communication module from the server of the media application through an audio casting function.

4. The electronic device of claim 1, wherein the instructions, when executed by the at least one processor individually or collectively, further cause the electronic device to:
in the state in which the audio is being played on the electronic device, based on the selection for transmitting the audio being played to the at least one external electronic device, search for the at least one external electronic device communicatively connected through the communication module;
control the display to display a list of external electronic devices including the searched at least one external electronic device; and
perform the audio mirroring function to transmit the audio being played to an external electronic device selected from the list of the external electronic devices.

5. The electronic device of claim 1, wherein the instructions, when executed by the at least one processor individually or collectively, further cause the electronic device to:
identify whether a media application providing the audio supports the audio mirroring function or whether the at least one external electronic device supports the audio mirroring function; and
based on the media application supporting the audio mirroring function or the at least one external electronic device supporting the audio mirroring function, perform the audio mirroring function to transmit the audio being played to the at least one external electronic device.

6. The electronic device of claim 1, wherein the instructions, when executed by the at least one processor individually or collectively, further cause the electronic device to:
based on a selection of an audio casting function being identified in a state in which the audio being played is transmitted through the audio mirroring function to a first external electronic device among the at least one external electronic device, identify whether a media application providing the audio supports a casting service in which a server of the media application is configured to be able to transmit the audio to the external electronic device; and
based on the media application supporting the casting service, transmit, to a second external electronic device among the at least one external electronic device, address information that enables the second external electronic device to receive the audio through the communication module from the server of the media application through the audio casting function.

7. The electronic device of claim 1, wherein the instructions, when executed by the at least one processor individually or collectively, further cause the electronic device to:
in a state in which a first audio provided from a first media application through the audio mirroring function is transmitted to a first external electronic device among the at least one external electronic device, based on identifying a selection of the audio mirroring function for a second audio provided from a second media application, perform the audio mirroring function to transmit the second audio to a second external electronic device among the at least one external electronic device.

8. The electronic device of claim 1, wherein the instructions, when executed by the at least one processor individually or collectively, further cause the electronic device to:
in a state in which a server of a first media application transmits a first audio to a second external electronic device among the at least one external electronic device through an audio casting function, based on identifying a selection of the audio mirroring function for a second audio provided from a second media application, perform the audio mirroring function to transmit the second audio from the electronic device to a first external electronic device among the at least one external electronic device.

9. The electronic device of claim 1, wherein the instructions, when executed by the at least one processor individually or collectively, further cause the electronic device to:
in a state in which the audio being played is transmitted to a first external electronic device among the at least one external electronic device through the audio mirroring function, based on a selection for changing the audio being played from the first external electronic device to a second external electronic device among the at least one external electronic device through an audio casting function, control the display to display a button for moving to a media application providing the audio to change to the second external electronic device.

10. The electronic device of claim 1, wherein the instructions, when executed by the at least one processor individually or collectively, further cause the electronic device to:
display a first icon indicating the electronic device and at least one second icon indicating the at least one external electronic device,
identify a selection of the first icon and a second icon among the at least one second icon using a gesture, and
transmit the audio being played to an external electronic device corresponding to the identified second icon through the audio mirroring function or an audio casting function.

11. An electronic device, comprising:
a communication module;
at least one processor; and
memory storing instructions that, when executed by the at least one processor individually or collectively, cause the electronic device to:
receive type information for receiving an audio from a plurality of external electronic devices communicatively connected through the communication module, wherein the type information indicates a capability of the plurality of external electronic devices to perform of an audio mirroring function or an audio casting function; and
in a state in which the electronic device plays a first audio provided from a first media application, transmit the first audio through the audio mirroring function to a first external electronic device where the type information for the audio reception includes first type information capable of an audio mirroring function among the plurality of external electronic devices;
play a second audio provided from a second media application, on the electronic device, in a state in which the first audio is being transmitted to the first external electronic device through the audio mirroring function; and
in a state in which the electronic device is playing the second audio provided from the second media application, transmit the second audio, through the audio casting function, to a second external electronic device.

12. The electronic device of claim 11, wherein the instructions, when executed by the at least one processor individually or collectively, further cause the electronic device to:
perform the audio mirroring function including separating the first audio being played on the electronic device from an audio output from the electronic device, recording the separated first audio, and transmitting the recorded first audio to the first external electronic device through the communication module.

13. The electronic device of claim 11, wherein the instructions, when executed by the at least one processor individually or collectively, further cause the electronic device to:
transmit, to the second external electronic device, address information that enables the second external electronic device to receive the second audio through the communication module from a server of the second media application through the audio casting function.

14. A method for transmitting an audio to an external electronic device by an electronic device, the method comprising:
playing an audio on the electronic device; and
performing an audio mirroring function comprising:
based on identifying a selection for transmitting the audio being played to an external electronic device, separating the audio being played from an audio output of the electronic device, recording the separated audio, and transmitting the recorded audio to the external electronic device through a communication module of the electronic device.

15. The method of claim 14, further comprising:
identifying whether a media application providing the audio on the electronic device supports a casting service in which a server of the media application is configured to be able to transmit the audio to the external electronic device; and
based on the media application not supporting the casting service, performing the audio mirroring function to transmit the audio being played to the external electronic device.

16. The method of claim 14, further comprising:
based on the media application supporting the casting service, transmitting, to the at least one external electronic device, address information that enables the at least one external electronic device to receive the audio through the communication module from the server of the media application through an audio casting function.

17. The method of claim 14, further comprising:
in the state in which the audio is being played on the electronic device, based on the selection for transmitting the audio being played to the at least one external electronic device, searching for the at least one external electronic device communicatively connected through the communication module;
controlling the display to display a list of external electronic devices including the searched at least one external electronic device; and
performing the audio mirroring function to transmit the audio being played to an external electronic device selected from the list of the external electronic devices.

18. The method of claim 14, further comprising:
Identifying whether a media application providing the audio supports the audio mirroring function or whether the at least one external electronic device supports the audio mirroring function; and
based on the media application supporting the audio mirroring function or the at least one external electronic device supporting the audio mirroring function, performing the audio mirroring function to transmit the audio being played to the at least one external electronic device.

19. The method of claim 14, further comprising:
based on a selection of an audio casting function being identified in a state in which the audio being played is transmitted through the audio mirroring function to a first external electronic device among the at least one external electronic device, identifying whether a media application providing the audio supports a casting service in which a server of the media application is configured to be able to transmit the audio to the external electronic device; and
based on the media application supporting the casting service, transmitting, to a second external electronic device among the at least one external electronic device, address information that enables the second external electronic device to receive the audio through the communication module from the server of the media application through the audio casting function.

20. The method of claim 14, further comprising:
in a state in which a first audio provided from a first media application through the audio mirroring function is transmitted to a first external electronic device among the at least one external electronic device, based on identifying a selection of the audio mirroring function for a second audio provided from a second media application, performing the audio mirroring function to transmit the second audio to a second external electronic device among the at least one external electronic device.
